(19) United States
(12) Patent Application Publication
(10) Pub. No.: US 2025/0130458 A1
(43) Pub. Date: Apr. 24, 2025

(54) OPTICAL ELEMENT AND DISPLAY DEVICE

(71) Applicant: Sharp Display Technology Corporation, Kameyama City (JP)

(72) Inventors: Jianeng XU, Kameyama City (JP); Yuichi KAWAHIRA, Kameyama City (JP); Masahiro HASEGAWA, Kameyama City (JP); Ryosuke SAIGUSA, Kameyama City (JP); Akira SAKAI, Kameyama City (JP)

(21) Appl. No.: 18/897,132

(22) Filed: Sep. 26, 2024

(30) Foreign Application Priority Data
Oct. 19, 2023 (JP) 2023-180153

(51) Int. Cl. G02F 1/1335

(52) U.S. Cl. CPC G02F 1/133528; G02F 1/133607

(57) ABSTRACT

The optical element includes: a first polarizer; a first retardation layer; a second retardation layer; and a second polarizer. First anisotropic molecules near the first polarizer are greater in tilt angle than first anisotropic molecules near an interface with the second retardation layer, with the tilt angles of the first anisotropic molecules continuously changing in a thickness direction. Second anisotropic molecules near the second polarizer are greater in tilt angle than second anisotropic molecules near an interface with the first retardation layer, with the tilt angles of the second anisotropic molecules continuously changing in a thickness direction. Transmission axes of the first and second polarizers are parallel. Slow axes of the first and second retardation layers are parallel. The transmission axis of the first polarizer is parallel to or orthogonal to the slow axes of the first and second retardation layers.

### CROSS-REFERENCE TO RELATED APPLICATIONS

The present application claims priority under 35 U.S.C. § 119 to Japanese Patent Application No. 2023-180153 filed on Oct. 19, 2023, the contents of which are incorporated herein by reference in their entirety.

### BACKGROUND OF THE INVENTION

### Field of the Invention

The following disclosure relates to optical elements and display devices including the optical element.

### Description of Related Art

Various display devices such as liquid crystal display devices and organic electroluminescent (EL) display devices have been widely used as devices that display images (moving images and still images). Optical elements are sometimes used in such display devices for the purpose of improving the viewability.

For example, WO 2017/110216 discloses an optical element that is a transmissive optical element including a polarizing plate and at least one tilt-alignment retardation film in the stated order from a viewing side, wherein (i) an absorption axis of the polarizing plate and a slow axis of the tilt-alignment retardation film are within the range of +15 degrees to +55 degrees and −15 degrees to −55 degrees, and (ii) the tilt-alignment retardation film introduces an in-plane retardation of from 110 nm to 240 nm and the average tilt angle γ relative to a plane of the film is from 22 degrees to 55 degrees.

### BRIEF SUMMARY OF THE INVENTION

Liquid crystal display devices are roughly classified into reflective liquid crystal display devices and transmissive liquid crystal display devices depending on the method of transmitting light through the liquid crystal layer. Transmissive liquid crystal display devices include a backlight including a light source, and perform display by transmitting light emitted from the backlight through a liquid crystal layer. The backlight may include a prism sheet (lens sheet) disposed on the observation surface side of the light source with an aim of focusing light from the light source to the front.

In a backlight including a prism sheet, some large-polar-angle light components of the light emitted from the light source and incident on the prism sheet may be scattered by the prisms (irregular structures) of the prism sheet, and the large-polar-angle light components may then be emitted from the prism sheet at a still larger polar angle without being collected to the front. Such a light component leaking at a large polar angle without being collected by the lens sheet is referred to as “side lobe light”. Side lobe light is essentially an unnecessary light component for image display and easily turns into stray light in the liquid crystal panel. Such stray light causes leakage of oblique light (large-polar-angle light) during black display, possibly being a factor of decreasing the contrast ratio during observation from an oblique direction.

The studies made by the present inventors suggest that some backlight structures easily cause side lobe light at the azimuths at the top and bottom positions. Thus, there is room for further improvement regarding light leakage in oblique directions at the azimuths at the top and bottom positions. The studies made by the present inventors also show that an image may appear in an unintended color during observation from an oblique direction, which leaves room for further improvement.

WO 2017/110216 includes consideration given to disposing a specific optical element on the observation surface side of the display device to reduce a decrease in viewability due to external light reflection. This document, however, does not mention any consideration on a decrease in contrast ratio due to side lobe light or coloring during observation from an oblique direction.

In response to the above issues, an object of the present invention is to provide an optical element that can reduce or prevent light leakage in oblique directions at the azimuths at the top and bottom positions and can reduce or prevent coloring during observation from an oblique direction; and a display device including the optical element.

(1) One embodiment of the present invention is directed to an optical element including, in the following order from an observation surface side: a first polarizer; a first retardation layer containing first anisotropic molecules; a second retardation layer containing second anisotropic molecules; and a second polarizer, wherein when a tilt angle of first anisotropic molecules of the first retardation layer located near the first polarizer is denoted by θ1-1, a tilt angle of first anisotropic molecules of the first retardation layer located near an interface with the second retardation layer is denoted by θ1-2, a tilt angle of second anisotropic molecules of the second retardation layer located near the second polarizer is denoted by θ2-1, and a tilt angle of second anisotropic molecules of the second retardation layer located near an interface with the first retardation layer is denoted by θ2-2, the θ1-1 is greater than the θ1-2, with the tilt angles of the first anisotropic molecules continuously changing in a thickness direction of the first retardation layer, the θ2-1 is greater than the θ2-2, with the tilt angles of the second anisotropic molecules continuously changing in a thickness direction of the second retardation layer, a transmission axis of the first polarizer is parallel to a transmission axis of the second polarizer, a slow axis of the first retardation layer is parallel to a slow axis of the second retardation layer, and the transmission axis of the first polarizer is parallel to or orthogonal to the slow axis of the first retardation layer and the slow axis of the second retardation layer.

(2) In an embodiment of the present invention, the optical element includes the structure (1), and the transmission axis of the first polarizer is parallel to the slow axis of the first retardation layer and the slow axis of the second retardation layer.

(3)

In an embodiment of the present invention, the optical element includes the structure (1), and the transmission axis of the first polarizer is orthogonal to the slow axis of the first retardation layer and the slow axis of the second retardation layer.

(4) In an embodiment of the present invention, the optical element includes the structure (2), and the θ1-1 and the θ2-1 are each 65° or greater and 90° or smaller.

(5) In an embodiment of the present invention, the optical element includes the structure (3), and the θ1-1 and the θ2-1 are each 70° or greater and 90° or smaller.

(6) In an embodiment of the present invention, the optical element includes the structures (1) to (5), and the θ1-1 and the θ2-1 are each 70° or greater and 80° or smaller.

(7) In an embodiment of the present invention, the optical element includes any one of the structures (1) to (6), and a difference between the θ1-1 and the θ2-1 is 3° or less.

(8) In an embodiment of the present invention, the optical element includes any one of the structures (1) to (7), and the tilt angles of the first anisotropic molecules and the second anisotropic molecules change respectively in the thickness direction of the first retardation layer and in the thickness direction of the second retardation layer, with an interface between the first retardation layer and the second retardation layer as a plane of symmetry.

(9) In an embodiment of the present invention, the optical element includes any one of the structures (1) to (8), the first polarizer is an absorptive polarizer or a laminate of an absorptive polarizer and a reflective polarizer, and the second polarizer is a reflective polarizer or a laminate of an absorptive polarizer and a reflective polarizer.

(10) Yet another embodiment of the present invention is directed to a display device including, in the following order: a liquid crystal panel; the optical element including any one of the structures (1) to (9); and a backlight, the optical element being disposed with the first polarizer being adjacent to the liquid crystal panel.

(11) In an embodiment of the present invention, the display device includes the structure (10), the backlight includes a prism sheet disposed in an optical element side of the backlight, the prism sheet includes lines of linear bumps parallel to each other on an observation surface side surface thereof, and a transmission axis of the first polarizer and a transmission axis of the second polarizer are parallel to or orthogonal to ridge lines of the linear bumps.

The present invention can provide an optical element that can reduce or prevent light leakage in oblique directions at the azimuths at the top and bottom positions and can reduce or prevent coloring during observation from an oblique direction; and a display device including the optical element.

### BRIEF DESCRIPTION OF THE DRAWINGS

FIG. 1 illustrates a polar angle and azimuthal angles.

FIG. 2 is a schematic cross-sectional view of an optical element of Embodiment 1.

FIG. 3 shows axis azimuths of components of the optical element of Embodiment 1.

FIG. 4 is a schematic cross-sectional view of the optical element of Embodiment 1 in a case where a first polarizer and a second polarizer are each a laminate.

FIG. 5 is a schematic cross-sectional view of an optical element of Embodiment 2.

FIG. 6 shows axis azimuths of components of the optical element of Embodiment 2.

FIG. 7 is a schematic cross-sectional view of a display device of Embodiment 3.

FIG. 8 is a perspective view of an example of a prism sheet included in a backlight.

FIG. 9 is a graph showing the transmittance in Example 1 and Example 2 when the tilt angle is varied.

FIG. 10 shows simulation results of the viewing angle in terms of color transmittance of an optical element of Example 1.

FIG. 11 is an xy chromaticity diagram of the optical element of Example 1 at a polar angle of 60° in the CIE 1931 color space.

FIG. 12 shows simulation results of the viewing angle in terms of color transmittance of an optical element of Example 2.

FIG. 13 is an xy chromaticity diagram of the optical element of Example 2 at a polar angle of 60° in the CIE 1931 color space.

FIG. 14 shows simulation results of the viewing angle in terms of transmittance of an optical element of Example 1.

FIG. 15 shows simulation results of the viewing angle in terms of transmittance of an optical element of Example 2.

FIG. 16 is a schematic cross-sectional view of an optical element of Comparative Example 1.

FIG. 17 shows axis azimuths of components of the optical element of Comparative Example 1.

FIG. 18 shows simulation results of the viewing angle in terms of transmittance of the optical element of Comparative Example 1.

FIG. 19 shows simulation results of the viewing angle in terms of color transmittance of the optical element of Comparative Example 1.

FIG. 20 is a schematic cross-sectional view of an optical element of Comparative Example 2.

FIG. 21 shows axis azimuths of components of the optical element of Comparative Example 2.

FIG. 22 shows simulation results of the viewing angle in terms of transmittance of the optical element of Comparative Example 2.

FIG. 23 shows simulation results of the viewing angle in terms of color transmittance of the optical element of Comparative Example 2.

FIG. 24 is a schematic cross-sectional view of an optical element of Comparative Example 3.

FIG. 25 shows axis azimuths of components of the optical element of Comparative Example 3.

FIG. 26 shows simulation results of the viewing angle in terms of transmittance of the optical element of Comparative Example 3.

FIG. 27 shows simulation results of the viewing angle in terms of color transmittance of the optical element of Comparative Example 3.

FIG. 28 is a schematic cross-sectional view of an optical element of Comparative Example 4.

FIG. 29 shows axis azimuths of components of the optical element of Comparative Example 4.

FIG. 30 shows simulation results of the viewing angle in terms of transmittance of the optical element of Comparative Example 4.

FIG. 31 shows simulation results of the viewing angle in terms of color transmittance of the optical element of Comparative Example 4.

FIG. 32 is a schematic cross-sectional view of an optical element of Comparative Example 5.

FIG. 33 shows axis azimuths of components of the optical element of Comparative Example 5.

FIG. 34 shows simulation results of the viewing angle in terms of transmittance of the optical element of Comparative Example 5.

FIG. 35 shows simulation results of the viewing angle in terms of color transmittance of the optical element of Comparative Example 5.

FIG. 36 is a schematic cross-sectional view of an optical element of Comparative Example 6.

FIG. 37 shows axis azimuths of components of the optical element of Comparative Example 6.

FIG. 38 shows simulation results of the viewing angle in terms of transmittance of the optical element of Comparative Example 6.

FIG. 39 shows simulation results of the viewing angle in terms of color transmittance of the optical element of Comparative Example 6.

### DETAILED DESCRIPTION OF THE INVENTION

Hereinafter, an embodiment of the present invention is described. The present invention is not limited to the contents described in the following embodiments. The design may be modified as appropriate within the range satisfying the configuration of the present invention. In the following description, components having the same or similar functions in different drawings are commonly provided with the same reference sign so as to appropriately avoid repetition of description. The structures in the present invention may be combined as appropriate without departing from the gist of the present invention.

### DEFINITION OF TERMS

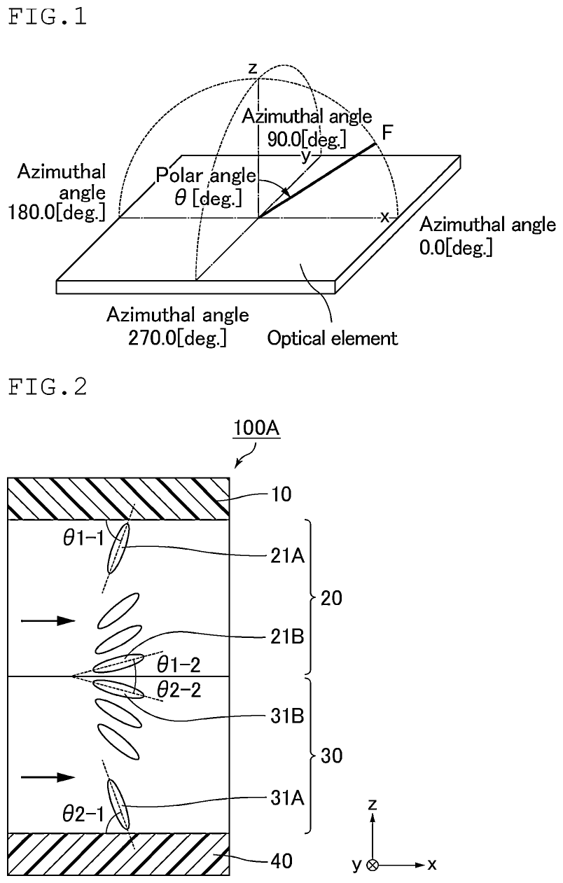

FIG. 1 shows a polar angle and azimuthal angles. The polar angle θ herein means, as shown in FIG. 1, an angle formed by the direction in question (e.g., measurement direction F) and a direction parallel to the normal of a main surface of an optical element. In other words, a direction parallel to the normal (z) of the main surface (xy plane) of the optical element corresponds to a polar angle of 0°. The direction parallel to the normal is also referred to as a normal direction. The “azimuth” herein means the direction in question in a view projected onto the main surface of the optical element and is expressed as an angle (also referred to as an azimuthal angle) formed with the reference azimuth. The reference azimuth (azimuthal angle of) 0° herein is set to the right in the horizontal direction of the screen of the optical element.

Herein, the expression that two axes (directions) are “parallel” means an angle (absolute value) formed by the two is within the range of 0°±3°, preferably within the range of 0°±1°, more preferably within the range of 0°±0.5°, particularly preferably 0° (perfectly parallel). The expression that two axes (directions) are “perpendicular” to each other means that the angle (absolute value) formed by the two is within the range of 90±3°, preferably within the range of 90°±1°, more preferably within the range of 90°±0.5°, particularly preferably 90° (completely perpendicular). Examples of the axes include the transmission axis and reflection axis of a polarizer and the slow axis of a retardation layer.

Herein, the observation surface side of the component in question means a side closer to the observer relative to the component, and the back surface side of the component in question means a side farther from the observer relative to the component, where the component in question is disposed to face the observer.

### Embodiment 1

An optical element of Embodiment 1 includes, in the following order from an observation surface side: a first polarizer; a first retardation layer containing first anisotropic molecules; a second retardation layer containing second anisotropic molecules; and a second polarizer, wherein when a tilt angle of first anisotropic molecules of the first retardation layer located near the first polarizer is denoted by θ1-1, a tilt angle of first anisotropic molecules of the first retardation layer located near an interface with the second retardation layer is denoted by θ1-2, a tilt angle of second anisotropic molecules of the second retardation layer located near the second polarizer is denoted by θ2-1, and a tilt angle of second anisotropic molecules of the second retardation layer located near an interface with the first retardation layer is denoted by θ2-2, the θ1-1 is greater than the θ1-2, with the tilt angles of the first anisotropic molecules continuously changing in a thickness direction of the first retardation layer, the θ2-1 is greater than the θ2-2, with the tilt angles of the second anisotropic molecules continuously changing in a thickness direction of the second retardation layer, a transmission axis of the first polarizer is parallel to a transmission axis of the second polarizer, a slow axis of the first retardation layer is parallel to a slow axis of the second retardation layer, and the transmission axis of the first polarizer is parallel to the slow axis of the first retardation layer and the slow axis of the second retardation layer.

FIG. 2 is a schematic cross-sectional view of the optical element of Embodiment 1. As shown in FIG. 2, an optical element 100A of Embodiment 1 includes, in the following order from the observation surface side, a first polarizer 10, a first retardation layer 20, a second retardation layer 30, and a second polarizer 40. The optical element 100A functions as an optical louver, and is thus also referred to as a polarizer louver. Herein, an optical element including all the components from the first polarizer 10 to the second polarizer 40 is called a polarizer louver.

### (Polarizer)

The first polarizer 10 and the second polarizer 40 each have a function of filtering unpolarized light (natural light), partially polarized light, or polarized light into polarized light (linearly polarized light) vibrating only in a specific direction. These polarizers are also referred to as linearly polarizing plates. The first polarizer 10 and the second polarizer 40 may each be an absorptive polarizer or a reflective polarizer. The absorptive polarizer has an absorption axis along which the polarizer absorbs light vibrating in a specific direction, and a transmission axis along which the polarizer transmits polarized light (linearly polarized light) vibrating in a direction orthogonal to the specific direction. The reflective polarizer has a reflection axis along which the polarizer reflects light vibrating in a specific direction and a transmission axis along which the polarizer transmits polarized light (linearly polarized light) vibrating in a direction orthogonal to the specific direction.

The first polarizer 10 and the second polarizer 40 may both be absorptive polarizers. The first polarizer 10 and the second polarizer 40 both as absorptive polarizers can absorb side lobe light when a backlight is disposed on or behind the back surface side of the optical element 100A, so that blocking of light in oblique directions at azimuths at the top and bottom positions can be further improved.

The first polarizer 10 may be an absorptive polarizer and the second polarizer 40 may be a reflective polarizer. When the second polarizer 40 on the back surface side is a reflective polarizer and a backlight is disposed on or behind the back surface side of the optical element 100A, light can be recycled by causing the second polarizer 40 to reflect side lobe light toward the backlight, and then causing a reflector of the backlight, for example, to emit the reflected light to the observation surface side again. This can increase the luminance in the normal direction during white display.

The first polarizer 10 and the second polarizer 40 may each be a laminate of an absorptive polarizer and a reflective polarizer. A reflective polarizer has an effect of increasing the luminance in the normal direction during white display, but has a lower degree of polarization than an absorptive polarizer. Thus, use of a reflective polarizer alone may decrease the contrast ratio of the polarizer louver. A laminate of an absorptive polarizer and a reflective polarizer is therefore used to increase the contrast ratio while improving the luminance in the normal direction.

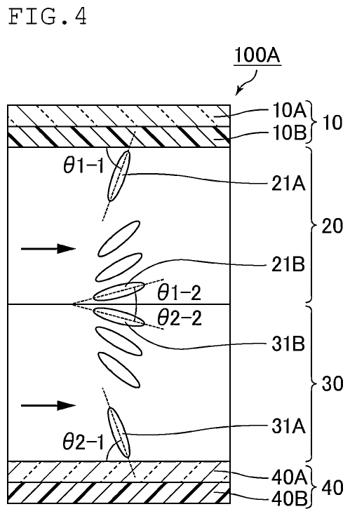

FIG. 4 is a schematic cross-sectional view of the optical element of Embodiment 1 in a case where a first polarizer and a second polarizer are each a laminate. In FIG. 4, an example is shown in which the first polarizer and the second polarizer are each a laminate of an absorptive polarizer and a reflective polarizer. When the first polarizer 10 is a laminate, preferably, an absorptive polarizer 10A and a reflective polarizer 10B are laminated in the stated order from the observation surface side. When the second polarizer 40 is a laminate, preferably, an absorptive polarizer 40A and a reflective polarizer 40B are laminated in the stated order from the observation surface side. When an absorptive polarizer and a reflective polarizer are laminated, preferably, the transmission axis of the absorptive polarizer 10A and the transmission axis of the reflective polarizer 10B are parallel to each other. Also preferably, the transmission axis of the absorptive polarizer 40A and the transmission axis of the reflective polarizer 40B are parallel to each other.

One of the first polarizer 10 and the second polarizer 40 may be a single-layer absorptive polarizer or reflective polarizer, and the other may be a laminate of an absorptive polarizer and a reflective polarizer. More preferably, both the first polarizer 10 and the second polarizer 40 are laminates of an absorptive polarizer and a reflective polarizer. Still more preferably, the first polarizer 10 and the second polarizer 40 each include a reflective polarizer on the back surface side of the absorptive polarizer. With such polarizers, the luminance and the contrast ratio can be further increased in a display device in which a liquid crystal panel is disposed on the front surface side of the optical element and a backlight is disposed on or behind the back surface side of the optical element. When the second polarizer 40, which is located on the backlight side, is a laminate of an absorptive polarizer and a reflective polarizer, the polarizer can reflect emission light from the backlight toward the backlight more efficiently to increase the efficiency of recycling light. When the first polarizer 10, which is located on the liquid crystal panel side, is a laminate of an absorptive polarizer and a reflective polarizer, light incident from the backlight side can further be reflected toward the backlight to further increase the front luminance of the liquid crystal panel.

Examples of the absorptive polarizer include those including a polarizing layer obtained by adsorbing a dichroic anisotropic material such as an iodine complex on a polyvinyl alcohol (PVA) film and aligning the material. A protective film such as a triacetyl cellulose (TAC) film may be disposed on at least one of the observation surface side or the back surface side of the polarizing layer.

Examples of the reflective polarizer include a reflective polarizer obtained by uniaxially stretching a co-extruded film made of multiple types of resins (e.g., APCF available from Nitto Denko Corporation, DBEF available from 3M Company), and a reflective polarizer including periodic arrays of metal thin lines (i.e., wire grid polarizer).

### (Retardation Layer)

The first retardation layer 20 and the second retardation layer 30 each have a function of utilizing its birefringent material or the like to introduce a retardation between the orthogonal two polarized light components, thereby changing the state of incident polarized light.

As shown in FIG. 2, the first retardation layer 20 contains first anisotropic molecules 21 and the second retardation layer 30 contains second anisotropic molecules 31. In FIG. 2, the tilt angle of first anisotropic molecules 21A of the first retardation layer 20 located near the first polarizer 10 is denoted by θ1-1; the tilt angle of first anisotropic molecules 21B of the first retardation layer 20 located near the interface with the second retardation layer 30 is denoted by θ1-2; the tilt angle of second anisotropic molecules 31A of the second retardation layer 30 located near the second polarizer 40 is denoted by θ2-1; and the tilt angle of second anisotropic molecules 31B of the second retardation layer 30 located near the interface with the first retardation layer 20 is denoted by θ2-2.

The θ1-1 is greater than the θ1-2, with the tilt angles of the first anisotropic molecules 21 continuously changing in the thickness direction of the first retardation layer 20. The tilt angle of the first anisotropic molecules 21 increases or decreases from one side toward the other side of the first retardation layer 20 in the thickness direction. The θ2-1 is greater than the θ2-2, with the tilt angles of the second anisotropic molecules 31 continuously changing in the thickness direction of the second retardation layer 30. The tilt angle of the second anisotropic molecules 31 increases or decreases from one side toward the other side of the second retardation layer 30 in the thickness direction. The θ1-1 differs from the θ1-2. The θ2-1 differs from the θ2-2. In other words, the first anisotropic molecules 21 and the second anisotropic molecules 31 are in the respective hybrid alignments. This structure can make the optical element 100A appear in a color close to a monochromatic color during observation from an oblique direction. Specifically, the yellowish color can be reduced to produce a blue monochromatic color. With the first retardation layer 20 taken as an example, in the thickness direction of the first retardation layer 20, the tilt angle of the first anisotropic molecules 21 (at a tilt angle of θ₂₁) located between the first anisotropic molecules 21A and the first anisotropic molecules 21B gradually changes in the thickness direction of the first retardation layer 20 within the range where the tilt angle θ21 satisfies the relationship θ1-2<θ₂₁<θ1-1.

The tilt angle of the first anisotropic molecules 21 means, unless otherwise specified, the angle at which the long axes of the first anisotropic molecules 21 are inclined relative to a surface parallel to the first retardation layer 20 side surface of the first polarizer 10. The tilt angle of the second anisotropic molecules 31 means, unless otherwise specified, the angle at which the long axes of the second anisotropic molecules 31 are inclined relative to a surface parallel to the second retardation layer 30 side surface of the second polarizer 40. The tilt angle is defined to be 0° or greater and 90° or smaller.

Preferably, the tilt angle of the first anisotropic molecules 21 increases from the interface between the first retardation layer 20 and the second retardation layer 30 toward the first polarizer 10 in the thickness direction of the first retardation layer 20, and the tilt angle of the second anisotropic molecules 31 increases from the interface toward the second polarizer 40 in the thickness direction of the second retardation layer 30. Since the first retardation layer 20 and the second retardation layer 30 in combination constitute a louver, the first retardation layer 20 and the second retardation layer 30 are preferably in contact with each other.

The tilt angles of the first anisotropic molecules 21 and the second anisotropic molecules 31 preferably change respectively in the thickness direction of the first retardation layer 20 and in the thickness direction of the second retardation layer 30, with an interface between the first retardation layer 20 and the second retardation layer 30 as a plane of symmetry.

Preferably, the direction of change in tilt angle of the first anisotropic molecules 21 of the first retardation layer 20 is the same as the direction of change in tilt angle of the second anisotropic molecules 31 of the second retardation layer 30. A direction of change in tilt angle of anisotropic molecules means the direction in which the long axes of the anisotropic molecules rise (the tilt angle increases). Specifically, the direction of change in tilt angle of the anisotropic molecules is the direction along the x-axis when a main surface of the optical element is defined as an xy-plane and a plane orthogonal to the main surface of the optical element and includes the long axes of multiple anisotropic molecules at a continuously changing tilt angle is defined as an xz-plane. The direction of change is also the direction from a first end toward a second end of the long axis of each of the above multiple anisotropic molecules. Here, the multiple anisotropic molecules at positions more distant from one surface (rising-target surface) selected from the interface between the first retardation layer 20 and the second retardation layer 30, the surface of the first retardation layer 20 facing the first polarizer 10, and the surface of the second retardation layer 30 facing the second polarizer 40, the second ends of the long axes of the anisotropic molecules more rise from the rising-target surface. In a cross-sectional view (e.g., FIG. 2) in an xz-plane, the direction of change in tilt angle of anisotropic molecules is indicated by the direction of an arrow.

In Embodiment 1, in order to further decrease the transmittance in oblique directions at azimuths at the top and bottom positions, the θ1-1 and the θ2-1 are preferably 65° or greater and 90° or smaller. In order to further reduce coloring in oblique directions, the θ1-1 and the θ2-1 are preferably 70° or greater and 80° or smaller.

The θ1-2 and the θ2-2 are smaller than the θ1-1 and the θ2-1 and are, for example, preferably 0° or greater and 10° or smaller, more preferably 1° or greater and 5° or smaller.

The difference between the θ1-1 and the θ2-1 is preferably 3° or smaller, more preferably 1° or smaller. Still more preferably, the θ1-1 and the θ2-1 are the same as each other. The difference between the θ1-2 and the θ2-2 is preferably 3° or smaller, more preferably 1° or smaller. Still more preferably, the θ1-2 and the θ2-2 are the same as each other.

The first anisotropic molecules 21 are preferably not twist-aligned in the thickness direction of the first retardation layer 20, and the second anisotropic molecules 31 are preferably not twist-aligned in the thickness direction of the second retardation layer 30. In other words, in a plan view from the observation surface side, the alignment azimuth of the first anisotropic molecules 21A of the first retardation layer 20 located near the first polarizer 10 is preferably parallel to the alignment azimuth of the first anisotropic molecules 21B of the first retardation layer 20 located near the interface with the second retardation layer 30. Also, in the plan view, the alignment azimuth of the second anisotropic molecules 31A of the second retardation layer 30 located near the second polarizer 40 is preferably parallel to the alignment azimuth of the second anisotropic molecules 31B of the second retardation layer 30 located near the interface with the first retardation layer 20.

The in-plane retardation of each of the first retardation layer 20 and the second retardation layer 30 is preferably 180 nm or more and 250 nm or less. This structure can more effectively reduce or prevent oblique light at azimuths at the top and bottom positions. The in-plane retardation of each of the first retardation layer 20 and the second retardation layer 30 is more preferably 190 nm or more and 240 nm or less, still more preferably 200 nm or more and 230 nm or less. A retardation herein is one introduced at 550 nm and measured at a temperature of 23° C., unless otherwise specified.

The in-plane retardation Re is defined by the following equation where d represents the thickness of the retardation layer, nx represents the refractive index in the x-axis direction, ny represents the refractive index in the y-axis direction, and nz represents the refractive index in the z-axis direction. The x-axis is set at azimuthal angle 0°-180°, the y-axis is set at azimuthal angle 90°-270°, and the z-axis is set perpendicular to the x-axis and the y-axis.

$$Re = ( nx - ny ) \times d$$

The color of the optical element 100A during observation from an oblique direction can preferably be made into a monochromatic color. The color is more preferably a blue monochromatic color because the color of the display device observed from an oblique direction can be easily corrected by changing the thickness of the liquid crystal layer in the liquid crystal panel disposed on the front surface side of the optical element 100A or changing the design of the viewing angle compensation film, for example. Specifically, the x and y values of the xy chromaticity diagram in the CIE 1931 color space preferably satisfy the relationships of x<0.33 and y<0.33, more preferably x<0.30 and y<0.30. The x and y values respectively refer to the average chromaticity values of x and y at a polar angle of 60° and an azimuthal angle of 0°, 45°, 90°, 135°, 180°, 225°, 270°, and 315°.

Examples of the first anisotropic molecules 21 and the second anisotropic molecules 31 include those exhibiting positive wavelength dispersion where the birefringence (retardation) decreases as the wavelength becomes longer. Anisotropic molecules with positive wavelength dispersion make the transmittance in oblique directions of the optical element 100A different at different wavelengths, thus causing the optical element 100A to be perceived in multiple colors in mixture. In order to correct such coloring during observation from oblique directions, an additional retardation layer can possibly be disposed that contains anisotropic molecules exhibiting reverse wavelength dispersion where the birefringence increases as the wavelength becomes longer. However, such anisotropic molecules exhibiting ideal wavelength dispersion which allows color correction do not exist yet. Thus, in the present embodiment, the color of the optical element 100A is made into a monochromatic color during observation from an oblique direction, so that the color of the display device during observation from an oblique direction can be corrected by changing the thickness of the liquid crystal layer in the liquid crystal panel disposed on the front surface side of the optical element 100A or the design of the viewing angle compensation film or the like. For example, the color of the liquid crystal panel during observation from an oblique direction is adjusted to be a color opposite to the color of the optical element 100A during observation from the oblique direction. When the color of the optical element 100A during observation from an oblique direction is blue, the color of the liquid crystal panel during observation from the oblique direction is designed to be a yellowish color.

The first anisotropic molecules 21 and the second anisotropic molecules 31 are molecules that cause the first retardation layer 20 and the second retardation layer 30 to exhibit birefringence, respectively. Specifically, the first anisotropic molecules 21 and the second anisotropic molecules 31, when aligned in specific directions, exhibit anisotropy in light refractive index. Examples of the first anisotropic molecules 21 and the second anisotropic molecules 31 include polymerizable liquid crystals, cured products of polymerizable liquid crystals, and other liquid crystalline materials. The polymerizable liquid crystals are described in detail below.

The first retardation layer 20 and the second retardation layer 30 may each be, for example, a reactive mesogen layer (coating retardation layer) made of a cured product of polymerizable liquid crystals (reactive mesogens). The coating retardation layer can be formed, for example, by coating an alignment film having undergone an alignment treatment with a composition containing polymerizable liquid crystals, followed by curing the polymerizable liquid crystals through baking, photoirradiation, or another method. The polymerized liquid crystals after the curing are aligned at the alignment azimuths of the alignment film defined by the alignment treatment to exhibit a retardation. The angle of inclination of the polymerizable liquid crystals located near the alignment film (the angle of inclination of the long axes of the polymerizable liquid crystals) relative to the alignment film is adjustable in increments of a few degrees by rubbing or another alignment treatment. The polymerizable liquid crystals can be aligned, for example, substantially horizontally to the alignment film. Meanwhile, polymerizable liquid crystals located near the surface opposite to the alignment film (surface in contact with the air) are aligned substantially perpendicularly to the surface in contact with the air due to the surface tension. The composition may contain a surfactant. Adjusting the concentration of the surfactant, for example, enables adjustment of the angle of inclination of the polymerizable liquid crystals relative to the surface in contact with the air. The angle of inclination of the obtained polymerizable liquid crystals in the retardation layer continuously changes in the thickness direction of the retardation layer to achieve a hybrid alignment. The angles of tilt of the first anisotropic molecules 21 and the second anisotropic molecules 31 can also be adjusted by adjusting the type of the polymerizable liquid crystals, the type of the surfactant, the firing conditions, the photoirradiation conditions (wavelength, intensity, irradiation angle of the irradiation light), and other conditions. The alignment film can be removed from the obtained retardation layer and can then be attached to a polarizer or another component with an adhesive, for example.

Examples of the alignment film used as a base of a coating retardation layer include those common in the field of liquid crystal panels, such as polyimide films. The alignment treatment for the alignment film can be rubbing, photoirradiation, or another treatment.

### (Axis Arrangement of Components)

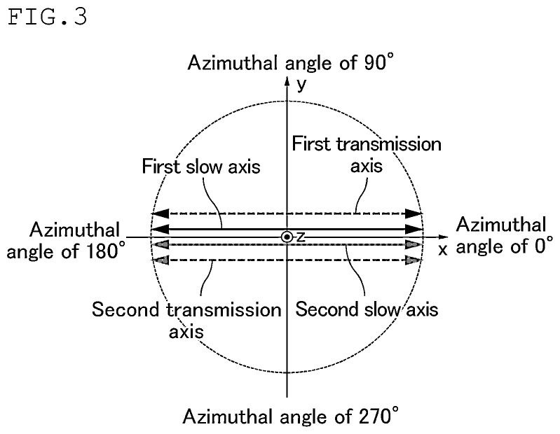

FIG. 3 shows axis azimuths of components of the optical element of Embodiment 1. As shown in FIG. 3, the transmission axis (hereinafter, also referred to as a first transmission axis) of the first polarizer 10 and the transmission axis (hereinafter, also referred to as a second transmission axis) of the second polarizer 40 are parallel to each other. The slow axis (hereinafter, also referred to as a first slow axis) of the first retardation layer 20 and the slow axis (hereinafter, also referred to as a second slow axis) of the second retardation layer 30 are parallel to each other. In a plan view of the first retardation layer 20 from the observation surface side, the long axis direction of the first anisotropic molecules 21 serves as the first slow axis. In a plan view of the second retardation layer 30 from the observation surface side, the long axis direction of the second anisotropic molecules 31 serves as the second slow axis. The first transmission axis is parallel to the first slow axis and the second slow axis. This structure can increase the contrast ratio in the normal direction while decreasing the transmittance in oblique directions at azimuths at the top and bottom positions to reduce light leakage.

In Embodiment 1, the first transmission axis is parallel to the first slow axis and the second slow axis. With the first transmission axis being parallel to the first slow axis and the second slow axis, the effect of blocking light in oblique directions at azimuths at the top and bottom positions can be further increased as compared with that in Embodiment 2.

The slow axis is measurable with a retardation measurement device (e.g., “Axoscan” available from Axometrics Inc.). Axoscan can measure a retardation, a slow axis, and a tilt angle of anisotropic molecules. Specifically, Axoscan measures a 4×4 matrix (Mueller matrix) containing 16 elements, which represents the polarization state of light, and then analyzes the measured values to determine the retardation, the slow axis, the tilt angle of the anisotropic molecules, and other properties.

### (Polymerizable Liquid Crystals)

The polymerizable liquid crystals are suitably of a liquid crystalline polymer having a photoreactive group. Examples of the liquid crystalline polymer having a photoreactive group include polymers each having a structure with both a mesogen group and a photoreactive group in its side chain and having an acrylate, methacrylate, maleimide, N-phenylmaleimide, or siloxane, or another structure in its main chain. The mesogen group may be a biphenyl group, a terphenyl group, a naphthalene group, a phenylbenzoate group, an azobenzene group, or a derivative of any of these groups, which are often used as a mesogen component of a liquid crystalline polymer. The photoreactive group may be a cinnamoyl group, a chalcone group, a cinnamylidene group, a β-(2-phenyl) acryloyl group, a cinnamic acid group, or a derivative of any of these groups.

The liquid crystalline polymer may be a homopolymer consisting of a single repeat unit or may be a copolymer consisting of two or more repeat units different in side chain structure. The copolymer encompasses all of alternating copolymers, random copolymers, graft copolymers. In the copolymer above, a side chain of at least one repeat unit has a structure including both the mesogen group and the photoreactive group, and a side chain of any other repeat unit may not have the mesogen group or the photoreactive group.

Preferred specific examples of the liquid crystalline polymer include copolymerizable (meth)acrylic acid polymers having a repeat unit represented by the following general formula (I).

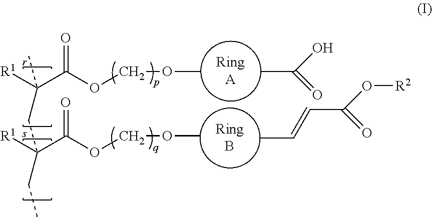

In the formula above, R¹ is a hydrogen atom or a methyl group; R₂ is an alkyl group, or a phenyl group substituted by a group selected from an alkyl group, an alkoxy group, a cyano group, and a halogen atom; ring A and ring B are each independently a group represented by any one of the following general formulas (M1) to (M5); p and q are each independently an integer of 1 to 12; and r and s are each a mole ratio of a monomer in a copolymer satisfying the relationships 0.65≤r≤ 0.95, 0.05≤ s≤0.35, and r+s=1.

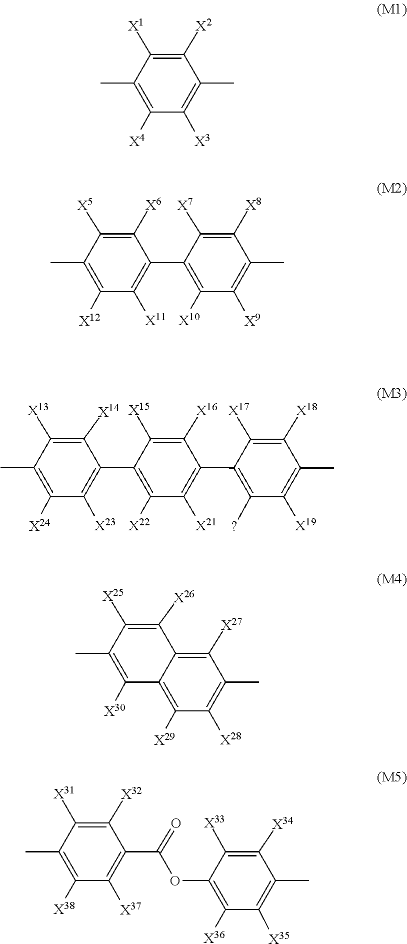

In the formulas above, X₁ to X₃₈ are each independently a hydrogen atom, an alkyl group, an alkoxy group, a halogen atom, or a cyano group.

Preferably, the liquid crystalline polymer is a copolymerizable (meth)acrylic acid polymer having a repeat unit represented by the following general formula (I-a).

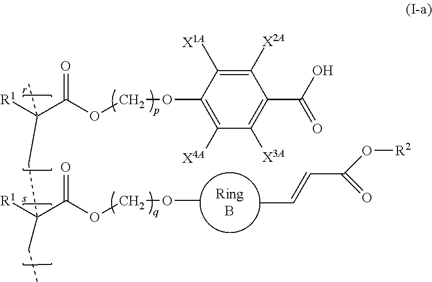

In the formula above, R¹ is a hydrogen atom or a methyl group; R² is an alkyl group, or a phenyl group substituted by a group selected from an alkyl group, an alkoxy group, a cyano group, and a halogen atom; X^{1A} to X^{4A} are each independently a hydrogen atom, an alkyl group, an alkoxy group, a halogen atom, or a cyano group; ring B is a group represented by the following general formula (M1a) or (M5a); p and q are each independently an integer of 1 to 12; and r and s are each a mole ratio of a monomer in a copolymer satisfying the relationships 0.65≤r≤0.95, 0.05≤s≤0.35, and r+s=1.

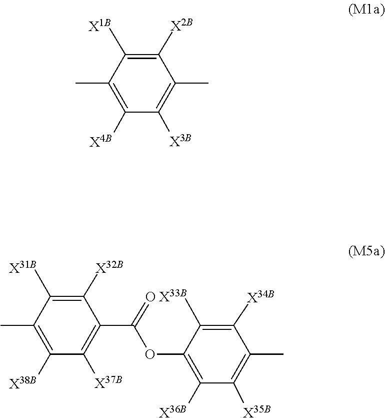

In the formulas above, X^{1B} to X^{4B} and X^{31B} to X^{38B} are each independently a hydrogen atom, an alkyl group, an alkoxy group, a halogen atom, or a cyano group.

In addition, the liquid crystalline polymer is more preferably a copolymerizable (meth)acrylic acid polymer having a repeat unit represented by the following general formula (I-b) or (I-c).

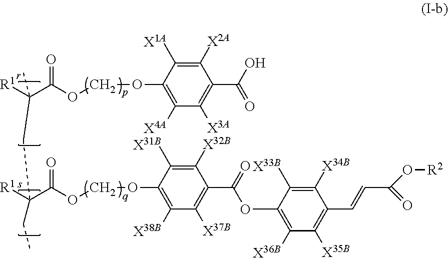

In the formula above, R¹ is a hydrogen atom or a methyl group; R² is an alkyl group, or a phenyl group substituted by a group selected from an alkyl group, an alkoxy group, a cyano group, and a halogen atom; X^{1A} to X^{4A} and X^{31B} to X^{38B} are each independently a hydrogen atom, an alkyl group, an alkoxy group, a halogen atom, or a cyano group; p and q are each independently an integer of 1 to 12; and r and s are each a mole ratio of a monomer in a copolymer satisfying the relationships 0.65≤r≤0.95, 0.05≤s≤0.35, and r+s=1.

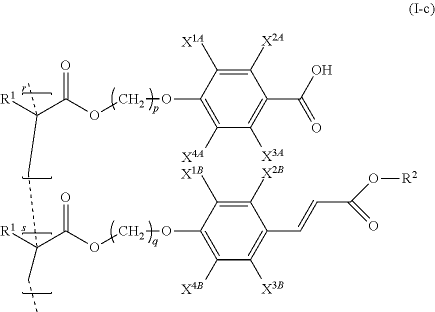

In the formula above, R¹ is a hydrogen atom or a methyl group; R² is an alkyl group, or a phenyl group substituted by a group selected from an alkyl group, an alkoxy group, a cyano group, and a halogen atom; X^{1A} to X^{4A} and X^{1B} to X^{4B} are each independently a hydrogen atom, an alkyl group, an alkoxy group, a halogen atom, or a cyano group; p and q are each independently an integer of 1 to 12; and r and s are each a mole ratio of a monomer in a copolymer satisfying the relationships 0.65≤r≤0.95, 0.05≤s≤0.35, and r+s=1.

In the general formula (I) (including the general formula (I-a), the general formula (I-b), and the general formula (I-c); the same holds for the following formulas), R¹ is preferably a methyl group; R² is preferably an alkyl group, or a phenyl group substituted by a group selected from an alkyl group, an alkoxy group, a cyano group, and a halogen atom, more preferably an alkyl group or a phenyl group substituted by an alkoxy group or a cyano group, particularly preferably an alkyl group or a phenyl group substituted by an alkoxy group.

X^{31B} to X^{38B} are each preferably a hydrogen atom or a halogen atom, and a case is most preferable where all of X^{31B} to X^{38B} are hydrogen atoms.

p and q are each preferably an integer of 3 to 9, preferably an integer of 5 to 7, most preferably 6. r is preferably in the range of 0.75≤r≤0.85, most preferably 0.8. Correspondingly, s is preferably in the range naturally derived from the relationship r+s=1. In other words, s is preferably in the range of 0.15≤s≤0.25, most preferably 0.2.

In the general formula (I-a), (I-b), or (I-c), X^{1A} to X^{4A} are each preferably a hydrogen atom or a halogen atom, and a case is particularly preferred where one of X^{1A} to X^{4A} is a halogen atom and the others are hydrogen atoms or where all of X^{1A} to X^{4A} are hydrogen atoms. In the general formula (I-b), X^{31B} to X^{38B} are each preferably a hydrogen atom or a halogen atom, and a case is most preferred where all of X^{31B} to X^{38B} are hydrogen atoms. In the general formula (I-c), X^{1B} to X^{4B} are each preferably a hydrogen atom or a halogen atom, and a case is most preferred where all of X^{1B} to X^{4B} are hydrogen atoms.

Examples of the alkyl group in R² or the alkyl group in the substituent of the phenyl group in R² include C1-C12 alkyl groups. Among these, preferred is a C1-C6 alkyl group, more preferred is a C1-C4 alkyl group, and most preferred is a methyl group. Examples of the alkoxy group in the substituent of the phenyl group in R² include C1-C12 alkoxy groups. Among these, preferred is a C1-C6 alkoxy group, more preferred is a C1-C4 alkoxy group, and most preferred is a methoxy group. Examples of the halogen group in the substituent of the phenyl group in R² include fluorine, chlorine, bromine, and iodine atoms, among which a fluorine atom is preferred.

Examples of the alkyl group in X¹ to X³⁸ include C1-C4 alkyl groups, among which a methyl group is most preferred. Examples of the alkoxy group in X¹ to X³⁸ include C1-C4 alkoxy groups, among which a methoxy group is most preferred. Examples of the halogen atom in X¹ to X³⁸ include fluorine, chlorine, bromine, and iodine atoms, among which a fluorine atom is preferred.

Herein, X^{1A} to X^{38A} indicate that X¹ to X³⁸, which are substituents on ring A or ring B, are those on ring A, and X^{1B} to X^{38B} indicate that X¹ to X³⁸ are those on ring B. Thus, description relating to X¹ to X³⁸ is directly applicable to X^{1A} to X^{38A} and X^{1B} to X^{38B}.

The liquid crystalline polymer can be dissolved in a solvent to be used as a retardation layer composition. The retardation layer composition may appropriately be mixed with a photopolymerization initiator, a surfactant, and a component usually included in a polymerizable composition that is polymerizable by light or heat.

Examples of the solvent used for the retardation layer composition include toluene, ethylbenzene, ethylene glycol monomethyl ether, ethylene glycol dimethyl ether, propylene glycol methyl ether, dibutyl ether, acetone, methyl ethyl ketone, ethanol, propanol, cyclohexane, cyclopentanone, methylcyclohexane, tetrahydrofuran, dioxane, cyclohexanone, n-hexane, ethyl acetate, butyl acetate, propylene glycol methyl ether acetate, methoxy butyl acetate, N-methyl pyrrolidone, and dimethylacetamide.

The photopolymerization initiator can be any known general photopolymerization initiator used to form a uniform film by application of a small amount of light. Specific examples thereof include azonitrile-based photopolymerization initiators such as 2,2′-azobisisobutyronitrile and 2,2′-azobis(2,4-dimethylvaleronitrile); x-amino ketone-based photopolymerization initiators such as IRGACURE 907 (available from Ciba Specialty Chemicals Inc.) and IRGACURE 369 (available from Ciba Specialty Chemicals Inc.); acetophenone-based photopolymerization initiators such as 4-phenoxydichloro acetophenone and 4-t-butyldichloroacetophenone; benzoin-based photopolymerization initiators such as benzoin and benzoin methyl ether; benzophenone-based photopolymerization initiators such as benzophenone and benzoylbenzoic acid; thioxanthone-based photopolymerization initiators such as 2-chlorothioxanthone and 2-methylthioxanthone; triazine-based photopolymerization initiators such as 2,4,6-trichloro-s-triazine and 2-phenyl-4,6-bis(trichloromethyl)-s-triazine; carbazole-based photopolymerization initiators, and imidazole-based photopolymerization initiators. Any of these photopolymerization initiators may be used alone or two or more of these may be used in combination.

The surfactant can be any surfactant generally used to form a uniform film. Specific examples thereof include anionic surfactants such as sodium lauryl sulfate and ammonium lauryl sulfate; nonionic surfactants such as polyethylene glycol monolaurate and sorbitan stearate; cationic surfactants such as stearyltrimethylammonium chloride and behenyltrimethylammonium chloride; amphoteric surfactants such as alkyl betaines including lauryl betaine and alkyl sulfobetaine, alkyl imidazoline, and sodium lauroyl sarcosinate; and surfactants such as BYK-361, BYK-306, BYK-307 (available from BYK Japan KK), Fluorad FC430 (available from Sumitomo 3M Limited), and Megaface F171 and R08 (available from DIC Corporation). Any of these surfactant may be used alone or two or more of these may be used in combination.

Polymerizable liquid crystals of a liquid crystalline polymer having a photoreactive group can be aligned by polarized light irradiation, for example. This allows formation of a coating retardation layer without an alignment film as a base material. As described above, formation of a coating retardation layer using a liquid crystalline polymer having a photoreactive group allows omission of an alignment film, thus thinning the optical element and simplifying the production steps.

### Embodiment 2

An optical element of Embodiment 2 has a structure similar to that in Embodiment 1, except that the transmission axis of the first polarizer is orthogonal to the slow axis of the first retardation layer and the slow axis of the second retardation layer, and thus description of matters already described above is omitted.

The optical element of Embodiment 2 includes, in the following order from an observation surface side: a first polarizer; a first retardation layer containing first anisotropic molecules; a second retardation layer containing second anisotropic molecules; and a second polarizer, wherein when a tilt angle of first anisotropic molecules of the first retardation layer located near the first polarizer is denoted by θ1-1, a tilt angle of first anisotropic molecules of the first retardation layer located near an interface with the second retardation layer is denoted by θ1-2, a tilt angle of second anisotropic molecules of the second retardation layer located near the second polarizer is denoted by θ2-1, and a tilt angle of second anisotropic molecules of the second retardation layer located near an interface with the first retardation layer is denoted by θ2-2, the θ1-1 is greater than the θ1-2, with the tilt angles of the first anisotropic molecules continuously changing in a thickness direction of the first retardation layer, the θ2-1 is greater than the θ2-2, with the tilt angles of the second anisotropic molecules continuously changing in a thickness direction of the second retardation layer, a transmission axis of the first polarizer is parallel to a transmission axis of the second polarizer, a slow axis of the first retardation layer is parallel to a slow axis of the second retardation layer, and the transmission axis of the first polarizer is orthogonal to the slow axis of the first retardation layer and the slow axis of the second retardation layer. This structure can increase the contrast ratio in the normal direction while decreasing the transmittance in oblique directions at azimuths at the top and bottom positions to reduce light leakage.

With the first transmission axis being orthogonal to the first slow axis and the second slow axis, the range of light blocking in oblique directions at azimuths at the top and bottom positions can be more widened than in Embodiment 1.

In Embodiment 2, in order to further decrease the transmittance in oblique directions at azimuths at the top and bottom positions, the θ1-1 and the θ2-1 are preferably 70° or greater and 90° or smaller. In order to further reduce coloring in oblique directions, the θ1-1 and the θ2-1 are preferably 70° or greater and 80° or smaller.

An optical element 100B of Embodiment 2 also can reduce light leakage in oblique directions at azimuths at the top and bottom positions and reduce or prevent coloring in oblique directions.

### Embodiment 3

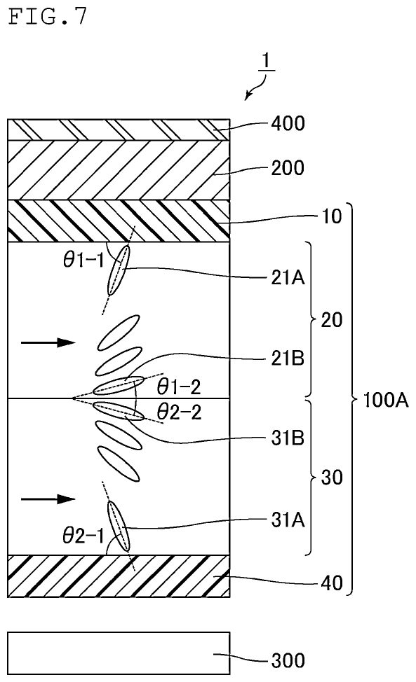

FIG. 7 is a schematic cross-sectional view of a display device of Embodiment 3. A display device 1 of Embodiment 3 includes in the following order: a liquid crystal panel 200; an optical element 100A; and a backlight 300. The optical element 100A is disposed with the first polarizer 10 being adjacent to the liquid crystal panel 200. The optical element may be either the optical element 100A of Embodiment 1 or the optical element 100B of Embodiment 2.

The display device 1 may include an observation surface side polarizer 400 on the observation surface side of the liquid crystal panel 200. The observation surface side polarizer 400 may be the absorptive polarizer or reflective polarizer described above, and is preferably the absorptive polarizer.

The transmission axis of the observation surface side polarizer 400 may be orthogonal or parallel to the transmission axis of the first polarizer 10. In order to achieve a high contrast ratio, the transmission axis of the observation surface side polarizer 400 is preferably orthogonal to the transmission axis of the first polarizer 10.

A liquid crystal panel usually has polarizers, one on the observation surface side and one on the back surface side. The first polarizer 10 preferably functions also as a polarizer on the back surface side of the liquid crystal panel. In other words, between the liquid crystal panel and the first polarizer 10, another polarizer is preferably not disposed. The first polarizer 10 may be, for example, attached to the back surface side of the liquid crystal panel 100 with a pressure-sensitive adhesive layer or the like.

### (Liquid Crystal Panel)

The liquid crystal panel 200 may include a pair of substrates and a liquid crystal layer held between the pair of substrates. The pair of substrates may be a color filter (CF) substrate including color filters and a TFT substrate including switching elements such as thin film transistors (TFTs).

The color filter substrate may include, for example, color filters and a black matrix which partitions the color filters. The TFT substrate may include gate lines and source lines crossing the gate lines and may have a structure in which TFTs are disposed at or near the intersections of the gate lines and the source lines and pixel electrodes electrically connected to the TFTs are disposed.

Examples of the liquid crystal panel include those in the vertical alignment (VA) mode, those in the fringe field switching (FFS) mode, those in the in-plane-switching (IPS) mode, and those in the twisted nematic (TN) mode.

In the VA mode, a counter electrode is disposed in the CF substrate and liquid crystal molecules in the liquid crystal layer may be aligned substantially perpendicularly to the substrate surface during no voltage application to the liquid crystal layer. In the FFS mode and the IPS mode, a counter electrode is disposed in the TFT substrate and liquid crystal molecules in the liquid crystal layer may be aligned substantially horizontally to the substrate surface during no voltage application to the liquid crystal layer. In the TN mode, a counter electrode is disposed in the CF substrate, and liquid crystal molecules in the liquid crystal layer may be spirally twisted from the TFT substrate toward the CF substrate by a rubbing treatment or another treatment. The alignment of the liquid crystal molecules is changed in response to the electric field generated in the liquid crystal layer by the voltage applied between the pixel electrodes and the counter electrode, so that the amount of light transmitted is controlled. Liquid crystal panels in a horizontal alignment mode such as the FFS mode or the IPS mode are suitable because the viewing angle in oblique directions is wide.

The liquid crystal panel may include alignment films, one between one of the substrates and the liquid crystal layer and one between the other substrate and the liquid crystal layer. The alignment films are layers having undergone an alignment treatment for controlling the alignment of liquid crystal molecules. Examples of the material of the alignment films include polymers having a structure such as a polyimide, polyamic acid, or polysiloxane structure in their main chain. A photoalignment film material having a photoreactive site (functional group) in its main chain or side chain is suitable.

The liquid crystal molecules may have a positive or negative anisotropy of dielectric constant (Δε) defined by the following formula (L). In order to increase the contrast ratio, the liquid crystal molecules preferably have a negative Δε.

Δε=(dielectric constant in long axis direction)−(dielectric constant in short axis direction) (L)

### (Backlight)

The backlight 300 may be any backlight that can irradiate the liquid crystal panel 100 with light, such as a direct-lit type or an edge-lit type. The backlight 300 may further include a light guide plate and a reflector, for example.

The backlight 300 may be one including light sources and a prism sheet disposed on the observation surface side of the light sources. The backlight 300 preferably includes a prism sheet disposed in the optical element side of the backlight 300. Examples of the light sources include cold cathode fluorescent lamps (CCFLs) and light emitting diodes (LEDs).

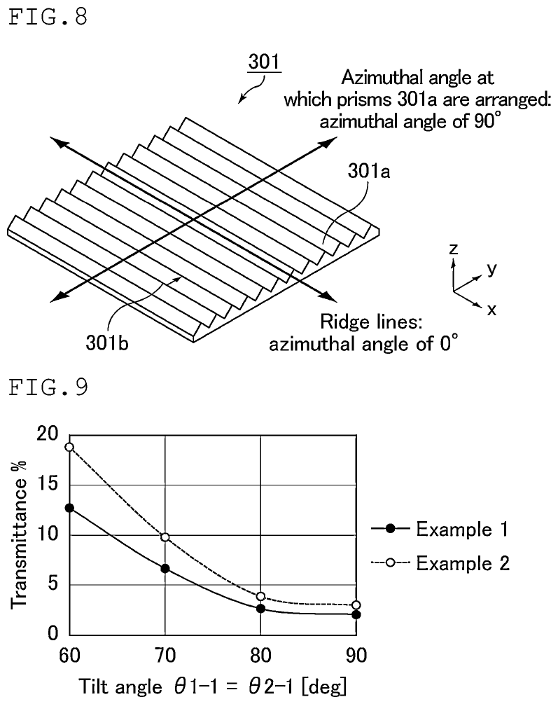

FIG. 8 is a perspective view of an example of a prism sheet included in a backlight. As shown in FIG. 8, a prism sheet 301 can be one including lines of prisms (linear bumps) 301a parallel to each other on an observation surface side surface. The linear continuous top apex of each linear bump 301a is also referred to as a ridge line 301b.

The ridge lines 301b are preferably parallel to an azimuthal angle of 0°. Specifically, the ridge lines 301b are preferably at an azimuthal angle of 0°±3°. With the ridge lines 301b formed parallelly to an azimuthal angle of 0°, collection of light by the prism sheet at the azimuths at the left and right positions (azimuthal angle 0°-180°) is reduced as compared with collection of light by the prism sheet at the azimuths at the top and bottom positions (azimuthal angle 90°-270°), so that the oblique luminance at the azimuths at the left and right positions can be increased to achieve a wide viewing angle. The prisms 301a in this case are arranged at an azimuthal angle of 90°. Such a structure is particularly suitable for OEM standards which require a wide luminance viewing angle at the azimuths at the left and right positions.

The transmission axis of the first polarizer 10 and the transmission axis of the second polarizer 40 are preferably parallel or orthogonal to the ridge lines 301b of the linear bumps. This structure allows more effective reduction or prevention of oblique light at azimuths at the top and bottom positions.

The azimuth at which side lobe light is generated varies, for example, depending on the positions of the ridge lines of the prism sheet(s) in the backlight. The studies made by the present inventors show that when a backlight is used that includes the prism sheet 301 with the ridge lines 301b being parallel to an azimuthal angle of 0° (azimuthal angle 0°-180°) or being parallel to an azimuthal angle of 90° (azimuthal angle) 90°-270°, oblique side lobe light easily occurs at the azimuths at the top and bottom positions (azimuthal angle 90°-270°). Thus, a backlight including the prism sheet 301 with the ridge lines 301b being parallel to an azimuthal angle of 0° (azimuthal angle) 0°-180° or parallel to an azimuthal angle of 90° (azimuthal angle) 90°-270° is combined with the optical element 100A of Embodiment 1 or the optical element 100B of Embodiment 2. This can make the azimuth and polar angle at which side lobe light occurs respectively match the azimuth and polar angle at which the transmittance can be reduced by the optical element 100A or 100B, so that side lobe light can be effectively reduced or prevented.

The backlight 300 may include a reflector on the back surface side of the light sources. Examples of the reflector include those usually used in the field of metal vapor-deposited films and display devices.

### EXAMPLES

The present invention will be described in more detail with reference to examples and comparative examples below, but the present invention is not limited only to these examples.

### Example 1

Example 1 is a specific example of Embodiment 1. FIG. 2 is also a schematic cross-sectional view of an optical element of Example 1. The optical element of Example 1 is also referred to as a polarizer louver. The optical element of Example 1 has a structure including, as shown in FIG. 2, in order from the observation surface side, a first polarizer 10, a first retardation layer 20 containing first anisotropic molecules 21, a second retardation layer 30 containing second anisotropic molecules 31, and a second polarizer 40.

FIG. 3 also shows axis azimuths of components of the optical element of Example 1. As shown in FIG. 3, in Example 1, the slow axis (first slow axis) of the first retardation layer, the slow axis (second slow axis) of the second retardation layer, the transmission axis (first transmission axis) of the first polarizer, and the transmission axis (second transmission axis) of the second polarizer were all parallel to one another (azimuthal angle) 0°-180°. The first polarizer and the second polarizer were single-layer absorptive linear polarizers.

As shown in FIG. 2, in Example 1, the tilt angle of the first anisotropic molecules 21 and the tilt angle of the second anisotropic molecules 31 were continuously changed to be symmetric about the interface between the first retardation layer 20 and the second retardation layer 30. The direction of change in tilt angle of the first anisotropic molecules 21 and the direction of change in tilt angle of the second anisotropic molecules 31 were set the same as each other. The in-plane retardations of the first retardation layer 20 and the second retardation layer 30 were each 213 nm.

### Example 2

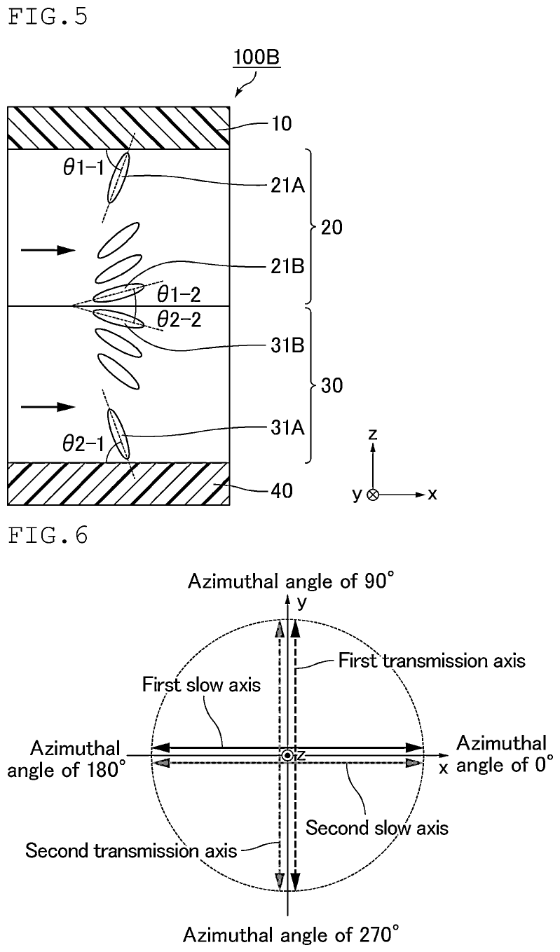

Example 2 is a specific example of Embodiment 2. FIG. 5 is a schematic cross-sectional view of an optical element of Example 2. FIG. 6 also shows axis azimuths of components of the optical element of Example 2. Example 2 employs a structure similar to that in Example 1, except that the arrangement of the first transmission axis and the second transmission axis is different. As shown in FIG. 6, in Example 2, the first slow axis and the second slow axis were set parallel (azimuthal angle) 0°-180° and the first transmission axis and the second transmission axis were set parallel (azimuthal angle) 90°-270°. The first transmission axis was set orthogonal to the first slow axis and the second slow axis.

### <Considerations on Tilt Angle and Transmittance>

In a polarizer louver with vertical light reduction where the transmittance at the azimuths at the top and bottom positions is reduced, the light transmittance at the azimuthal angle 90°-270° and a polar angle of 60° is desirably 10% or lower. The following shows the simulation of the transmittance in Examples 1 and 2 during observation at the azimuthal angle 90°-270° and a polar angle of 60° while the θ1-2 and the θ2-2 were fixed at 4° and the θ1-1 and 02-1 angles were varied to 60°, 70°, 80°, and 90°, where θ1-1=θ2-1. The simulation was performed using an LCD Master.

FIG. 9 is a graph showing the transmittance in Example 1 and Example 2 when the tilt angle is varied. FIG. 9 suggests that excellent light-blocking properties were achieved as the transmittance was 10% or lower when the θ1-1 and the θ2-1 were 65° or greater in Example 1 and when the θ1-1 and the θ2-1 were 70° or greater in Example 2.

### <Evaluation of Coloring at Polar Angle of 60°>

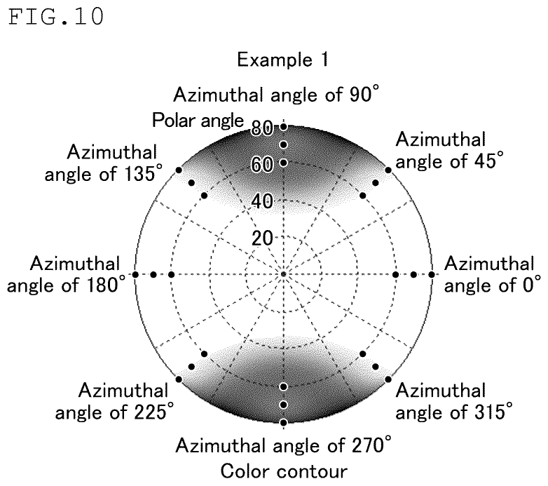

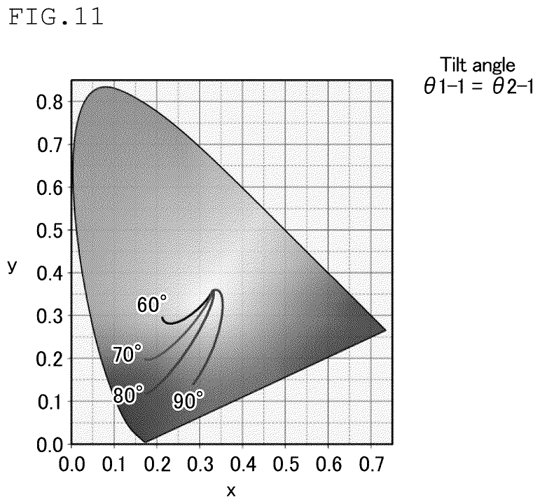

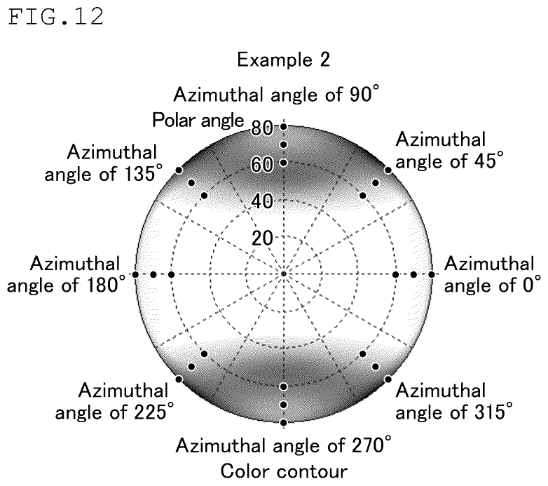

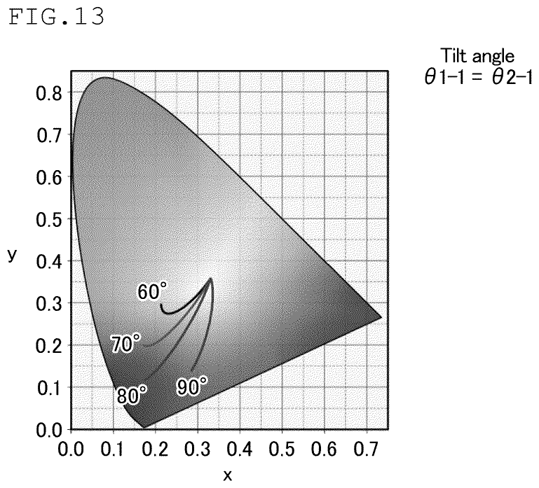

A case was examined where the color observed at a polar angle of 60° was a blue monochromatic color, for improvement of the coloring during observation from an oblique direction. For Examples 1 and 2, the chromaticity values (x, y) were simulated at all the azimuthal angles (azimuthal angles of 0° to 360°) at a polar angle of 60° while the θ1-2 and the θ2-2 were fixed at 4° and the θ1-1 and θ2-1 angles were varied to 60°, 70°, 80°, and 90°, where θ1-1=θ2-1. The simulation was performed with an LCD Master. FIG. 10 shows simulation results of the viewing angle in terms of color transmittance of the optical element of Example 1. FIG. 11 is an xy chromaticity diagram of the optical element of Example 1 at a polar angle of 60° in the CIE 1931 color space. FIG. 12 shows simulation results of the viewing angle in terms of color transmittance of the optical element of Example 2. FIG. 13 is an xy chromaticity diagram of the optical element of Example 2 at a polar angle of 60° in the CIE 1931 color space. In the contour diagram of the viewing angle in terms of color transmittance, the dark color portions indicate portions where coloring was observed.

The following Table 1 summarizes the x and y values in the contour diagram of the viewing angle in terms of color transmittance in FIG. 10 and those in the xy chromaticity diagram in FIG. 11. The following Table 2 summarizes the x and y values in the contour diagram of the viewing angle in terms of color transmittance in FIG. 12 and those in the xy chromaticity diagram in FIG. 13. The x and y values respectively mean the average chromaticity values of the x and y values at azimuthal angles of 0°, 45°, 90°, 135°, 180°, 225°, 270°, and 315° and a polar angle of 60°. When the coloring at a polar angle of 60° is designed to be a blue monochromatic color, the average chromaticity values of x and y at a polar angle of 60° in the CIE 1931 color space are respectively preferably x<0.33 and y<0.33, more preferably x<0.30 and y<0.30.

TABLE 1

| | θ1-1 = | | θ1-1 = | | θ1-1 = | | θ1-1 = | |
|---|---|---|---|---|---|---|---|---|
| Azimuthal | θ2-1 = 60° | | θ2-1 = 70° | | θ2-1 = 80° | | θ2-1 = 90° | |
| angle [deg] | x | y | x | y | x | y | x | y |
| 0 | 0.33 | 0.36 | 0.33 | 0.36 | 0.33 | 0.36 | 0.33 | 0.36 |
| 45 | 0.29 | 0.31 | 0.30 | 0.30 | 0.32 | 0.32 | 0.35 | 0.35 |
| 90 | 0.21 | 0.30 | 0.17 | 0.20 | 0.17 | 0.12 | 0.28 | 0.14 |
| 135 | 0.29 | 0.31 | 0.30 | 0.30 | 0.32 | 0.32 | 0.35 | 0.35 |
| 180 | 0.33 | 0.36 | 0.33 | 0.36 | 0.33 | 0.36 | 0.33 | 0.36 |
| 225 | 0.29 | 0.31 | 0.30 | 0.30 | 0.32 | 0.32 | 0.35 | 0.35 |
| 270 | 0.21 | 0.30 | 0.17 | 0.20 | 0.17 | 0.12 | 0.28 | 0.14 |
| 315 | 0.29 | 0.31 | 0.30 | 0.30 | 0.32 | 0.32 | 0.35 | 0.35 |
| Average | 0.28 | 0.32 | 0.28 | 0.29 | 0.29 | 0.28 | 0.33 | 0.30 |
| chromaticity | | | | | | | | |
| value | | | | | | | | |

TABLE 2

| | θ1-1 = | | θ1-1 = | | θ1-1 = | | θ1-1 = | |
|---|---|---|---|---|---|---|---|---|
| Azimuthal | θ2-1 = 60° | | θ2-1 = 70° | | θ2-1 = 80° | | θ2-1 = 90° | |
| angle [deg] | x | y | x | y | x | y | x | y |
| 0 | 0.33 | 0.36 | 0.33 | 0.36 | 0.33 | 0.36 | 0.33 | 0.36 |
| 45 | 0.27 | 0.29 | 0.27 | 0.27 | 0.30 | 0.29 | 0.34 | 0.32 |
| 90 | 0.21 | 0.30 | 0.17 | 0.20 | 0.17 | 0.12 | 0.29 | 0.14 |
| 135 | 0.27 | 0.29 | 0.27 | 0.27 | 0.30 | 0.29 | 0.34 | 0.32 |
| 180 | 0.33 | 0.36 | 0.33 | 0.36 | 0.33 | 0.36 | 0.33 | 0.36 |
| 225 | 0.27 | 0.29 | 0.27 | 0.27 | 0.30 | 0.29 | 0.34 | 0.32 |
| 270 | 0.21 | 0.30 | 0.17 | 0.20 | 0.17 | 0.12 | 0.29 | 0.14 |
| 315 | 0.27 | 0.29 | 0.27 | 0.27 | 0.30 | 0.29 | 0.34 | 0.32 |
| Average | 0.27 | 0.31 | 0.26 | 0.28 | 0.28 | 0.26 | 0.32 | 0.29 |
| chromaticity | | | | | | | | |
| value | | | | | | | | |

The results in Tables 1 and 2 show that in both Examples 1 and 2, the average chromaticity values were x<0.33 and y<0.33 when the θ1-1 and the θ2-1 were 60° or greater and 90° or smaller. The average chromaticity values were x<0.30 and y<0.30 when the θ1-1 and the θ2-1 were 70° or greater and 80° or smaller, meaning that the yellowish color was further reduced to achieve a color closer to a blue monochromatic color.

The transmittances shown in FIG. 9 in combination with the results shown in Table 1 and Table 2 show that when the θ1-1 and the θ2-1 are 80°, a color close to a blue monochromatic color can be achieved while light-blocking properties are achieved at the azimuths at the top and bottom positions.

### <Transmittance in Oblique Directions>

In Examples 1 and 2, with θ1−1=70°, θ2−1=70°, 01-2=4°, and θ2−2=4°, as shown in FIG. 2, the first retardation layer 20 was in a hybrid alignment where the tilt angle of the first anisotropic molecules continuously increases from the interface between the first retardation layer 20 and the second retardation layer 30 toward the first polarizer 10. The second retardation layer 30 was in a hybrid alignment where the tilt angle of the second anisotropic molecules continuously increases from the interface toward the second polarizer 40.

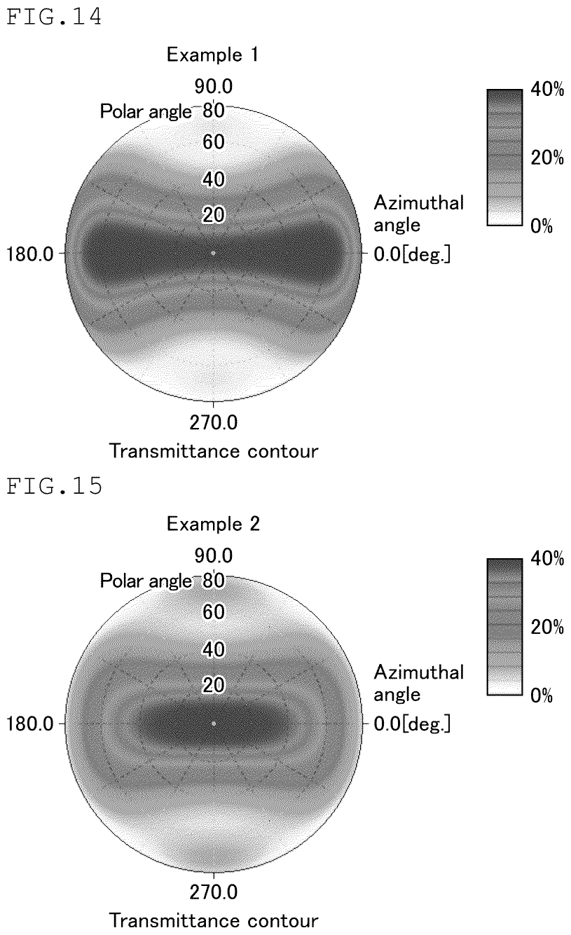

The LCD Master was used to simulate the viewing angle in terms of transmittance of the optical elements of Examples 1 and 2, and the results were plotted on contour diagrams. FIG. 14 shows simulation results of the viewing angle in terms of transmittance of the optical element of Example 1. FIG. 15 shows simulation results of the viewing angle in terms of transmittance of the optical element of Example 2. The dotted line circles in each contour diagram indicate polar angles of 200, 40°, 60°, and 80° from the inside. The shades of the contour diagram of the viewing angle in terms of transmittance correspond to the transmittances shown to the right in each figure. As shown in FIG. 14 and FIG. 15, the optical elements of Examples 1 and 2 successfully reduced light transmitted in oblique directions at the azimuths at the top and bottom positions (azimuthal angle) 90°-270°, and transmission of light was reduced horizontally symmetrically about the azimuthal angle 90°-270°. Hereinbelow, light transmitted in oblique directions (in particular, polar angles of 60° to) 80° is also referred to as “oblique light”.

### Comparative Example 1

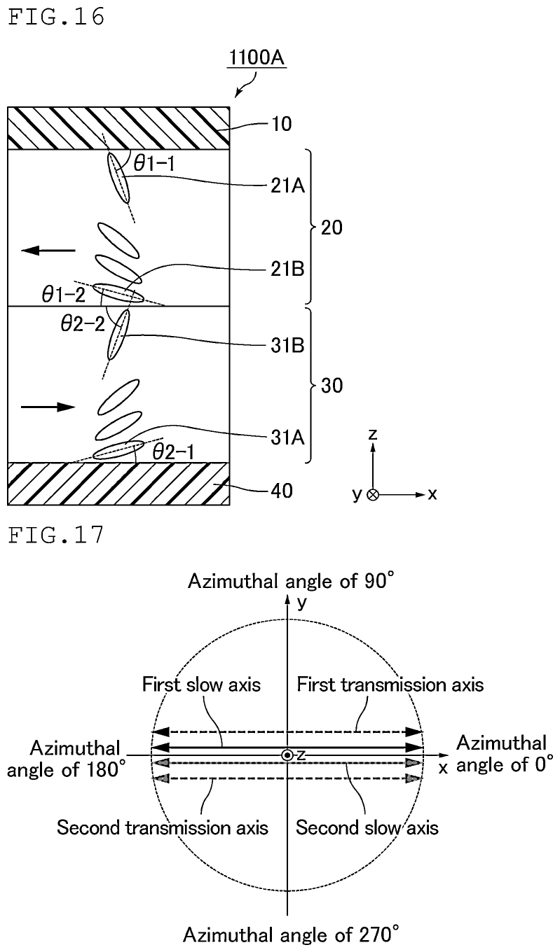

FIG. 16 is a schematic cross-sectional view of an optical element of Comparative Example 1. FIG. 17 shows axis azimuths of components of the optical element of Comparative Example 1. As shown in FIG. 17, the axis arrangement of the components was similar to that in Example 1. In an optical element 1100A of Comparative Example 1, θ1−1=70°, θ2−1=4°, θ1−2=4°, and θ2−2=70°. The in-plane retardation introduced by each of the first retardation layer 20 and the second retardation layer 30 was 213 nm.

As shown in FIG. 16, the first retardation layer 20 was in a hybrid alignment where the tilt angle of the first anisotropic molecules continuously increases from the interface between the first retardation layer 20 and the second retardation layer 30 toward the first polarizer 10. The second retardation layer 30 was in a hybrid alignment where the tilt angle of the second anisotropic molecules continuously decreases from the interface toward the second polarizer 40. The changes in tilt angle of the first anisotropic molecules 21 and the second anisotropic molecules 31 were asymmetric about the interface between the first retardation layer 20 and the second retardation layer 30. The direction of change in tilt angle of the first anisotropic molecules 21 was opposite to the direction of change in tilt angle of the second anisotropic molecules 31.

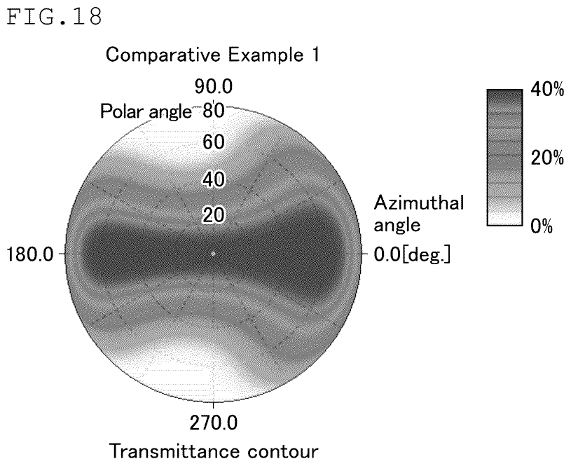

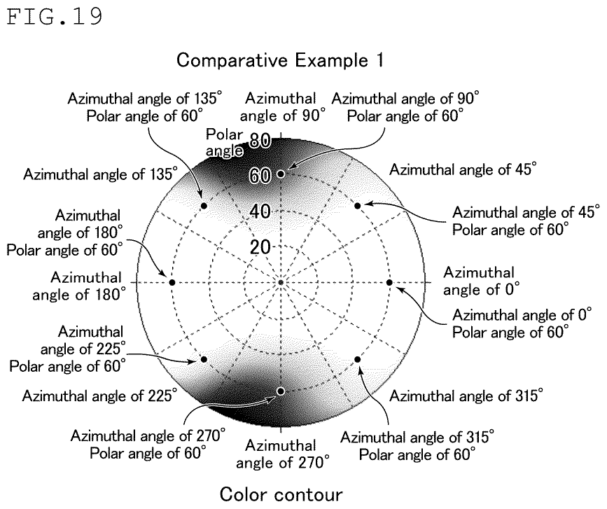

As in Example 1, the viewing angle in terms of transmittance and the coloring in the optical element of Comparative Example 1 were simulated. FIG. 18 shows simulation results of the viewing angle in terms of transmittance of the optical element of Comparative Example 1. FIG. 19 shows simulation results of the viewing angle in terms of color transmittance of the optical element of Comparative Example 1. The following Table 3 summarizes the x and y values in the xy chromaticity diagram of the optical element of Comparative Example 1 shown in FIG. 19 at a polar angle of 60° in the CIE 1931 color space. As shown in FIG. 18, the optical element of Comparative Example 1 successfully reduced oblique light at the azimuthal angle 90°-270°, but the light-blocking region was horizontally asymmetric about the azimuthal angle 90°-270°. As shown in FIG. 19 and Table 3, a bluish color and a yellowish color in mixture were observed at an oblique angle (polar angle of) 60°.

TABLE 3

| Azimuthal | | |
|---|---|---|
| angle [deg] | x | y |
| 0 | 0.33 | 0.36 |
| 45 | 0.41 | 0.43 |
| 90 | 0.32 | 0.16 |
| 135 | 0.33 | 0.32 |
| 180 | 0.33 | 0.36 |
| 225 | 0.33 | 0.32 |
| 270 | 0.32 | 0.16 |
| 315 | 0.41 | 0.43 |
| Average | 0.35 | 0.32 |
| chromaticity | | |
| value | | |

### Comparative Example 2

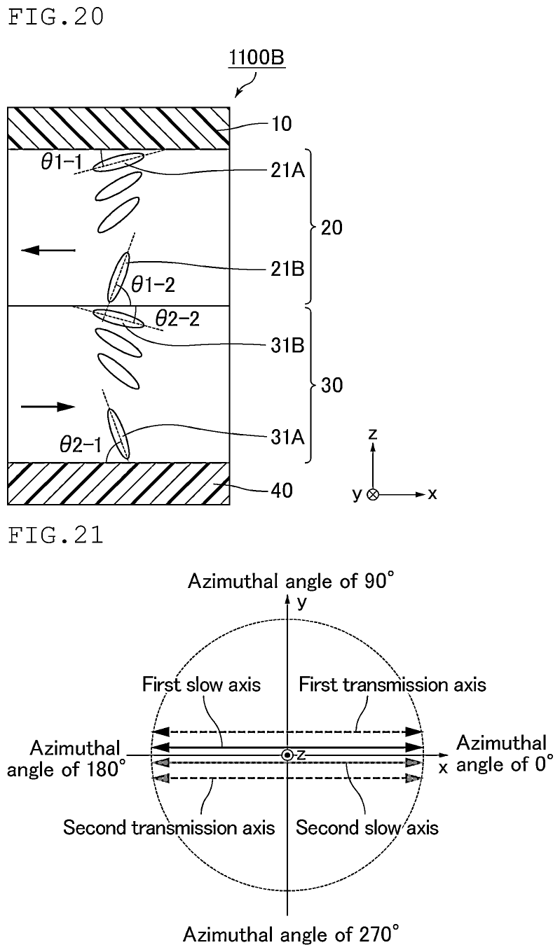

FIG. 20 is a schematic cross-sectional view of an optical element of Comparative Example 2. FIG. 21 shows axis azimuths of components of the optical element of Comparative Example 2. As shown in FIG. 21, the axis arrangement of the components was similar to that in Example 1. In an optical element 1100B of Comparative Example 2, θ1−1=4°, θ2−1=70°, θ1−2=70°, and θ2−2=4°. The in-plane retardation introduced by each of the first retardation layer 20 and the second retardation layer 30 was 213 nm.

As shown in FIG. 20, the first retardation layer 20 was in a hybrid alignment where the tilt angle of the first anisotropic molecules continuously decreases from the interface between the first retardation layer 20 and the second retardation layer 30 toward the first polarizer 10. The second retardation layer 30 was in a hybrid alignment where the tilt angle of the second anisotropic molecules continuously increases from the interface toward the second polarizer 40. The changes in tilt angle of the first anisotropic molecules 21 and the second anisotropic molecules 31 were set asymmetric about the interface between the first retardation layer 20 and the second retardation layer 30. The direction of change in tilt angle of the first anisotropic molecules 21 was opposite to the direction of change in tilt angle of the second anisotropic molecules 31.

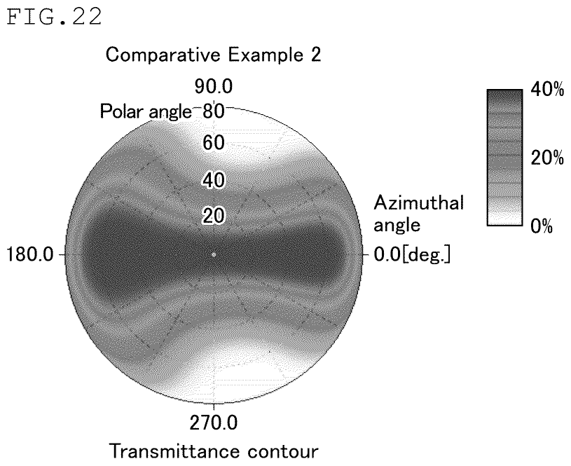

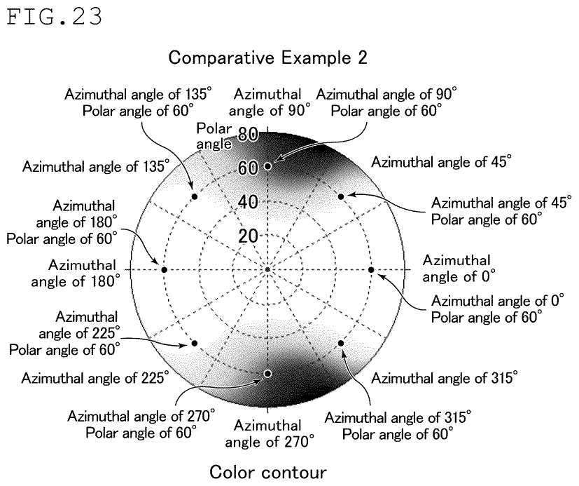

As in Example 1, the viewing angle in terms of transmittance and the coloring in the optical element of Comparative Example 2 were simulated. FIG. 22 shows simulation results of the viewing angle in terms of transmittance of the optical element of Comparative Example 2. FIG. 23 shows simulation results of the viewing angle in terms of color transmittance of the optical element of Comparative Example 2. The following Table 4 summarizes the x and y values in the xy chromaticity diagram of the optical element of Comparative Example 2 shown in FIG. 23 at a polar angle of 60° in the CIE 1931 color space. As shown in FIG. 22, the optical element of Comparative Example 2 successfully reduced oblique light at the azimuthal angle 90°-270°, and the light-blocking region was horizontally asymmetric about the azimuthal angle 90°-270°. As shown in FIG. 23 and Table 4, a bluish color and a yellowish color in mixture were observed at an oblique angle (polar angle of) 60°.

TABLE 4

| Azimuthal | | |
|---|---|---|
| angle [deg] | x | y |
| 0 | 0.33 | 0.36 |
| 45 | 0.33 | 0.32 |
| 90 | 0.32 | 0.16 |
| 135 | 0.41 | 0.43 |
| 180 | 0.33 | 0.36 |
| 225 | 0.41 | 0.43 |
| 270 | 0.32 | 0.16 |
| 315 | 0.33 | 0.32 |
| Average | 0.35 | 0.32 |
| chromaticity | | |
| value | | |

### Comparative Example 3

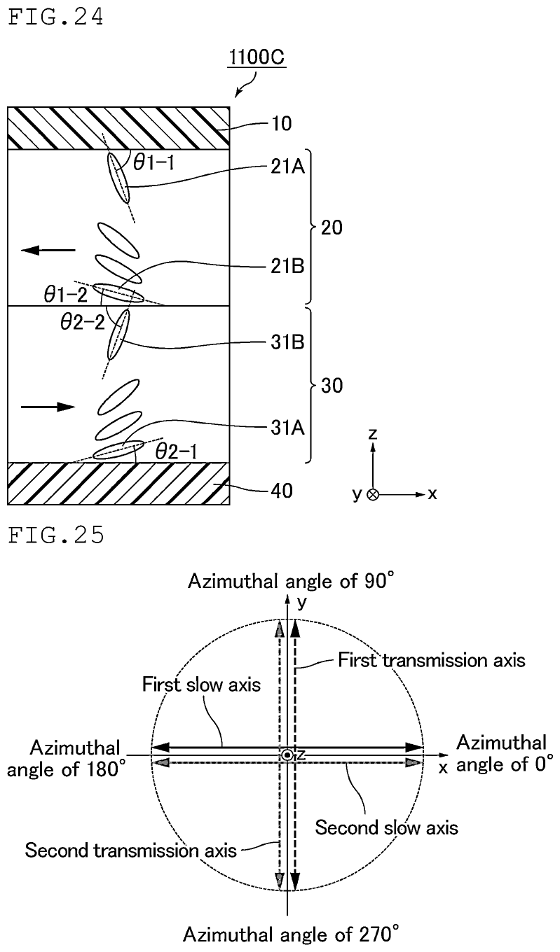

FIG. 24 is a schematic cross-sectional view of an optical element of Comparative Example 3. FIG. 25 shows axis azimuths of components of the optical element of Comparative Example 3. As shown in FIG. 25, the axis arrangement of the components was similar to that in Example 2. In an optical element 1100C of Comparative Example 3, with θ1-1=4°, θ2-1=70°, 01-2=70°, and θ2-2=4°, as shown in FIG. 24, the first anisotropic molecules in the first retardation layer 20 and the second anisotropic molecules in the second retardation layer 30 were in the respective hybrid alignments as in Comparative Example 2.

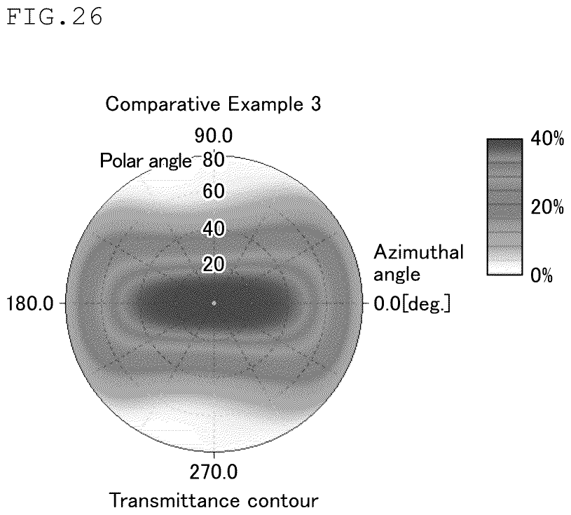

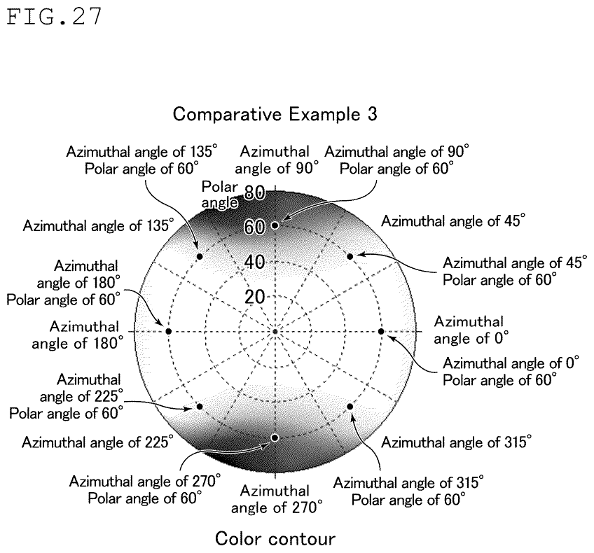

As in Example 1, the viewing angle in terms of transmittance and the coloring in the optical element of Comparative Example 3 were simulated. FIG. 26 shows simulation results of the viewing angle in terms of transmittance of the optical element of Comparative Example 3. FIG. 27 shows simulation results of the viewing angle in terms of color transmittance of the optical element of Comparative Example 3. The following Table 5 summarizes the x and y values in the xy chromaticity diagram of the optical element of Comparative Example 3 shown in FIG. 27 at a polar angle of 60° in the CIE 1931 color space. As shown in FIG. 26, the optical element of Comparative Example 3 successfully reduced oblique light at the azimuthal angle 90°-270°, but the light-blocking region was horizontally asymmetric about the azimuthal angle 90°-270° although being better than that in Comparative Example 1. As shown in FIG. 27 and Table 5, a bluish color and a yellowish color in mixture were observed at an oblique angle (polar angle of) 60°.

TABLE 5

| Azimuthal | | |
|---|---|---|
| angle [deg] | x | y |
| 0 | 0.33 | 0.36 |
| 45 | 0.38 | 0.38 |
| 90 | 0.43 | 0.26 |
| 135 | 0.34 | 0.32 |
| 180 | 0.33 | 0.36 |
| 225 | 0.34 | 0.32 |
| 270 | 0.43 | 0.26 |
| 315 | 0.38 | 0.38 |
| Average | 0.37 | 0.33 |
| chromaticity | | |
| value | | |

### Comparative Example 4

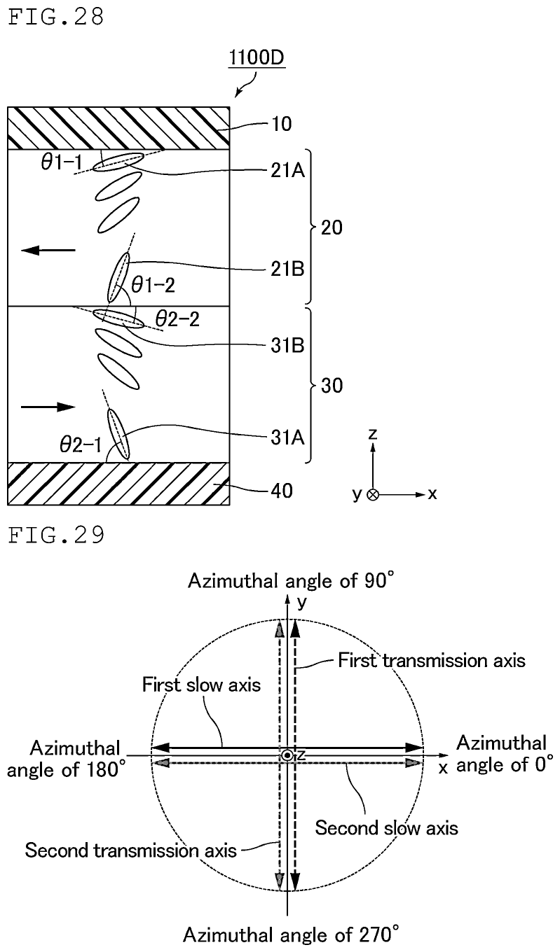

FIG. 28 is a schematic cross-sectional view of an optical element of Comparative Example 4. FIG. 29 shows axis azimuths of components of the optical element of Comparative Example 4. As shown in FIG. 29, the axis arrangement of the components was similar to that in Example 2. In an optical element 1100D of Comparative Example 4, with θ1-1=4°, θ2-1=70°, 01-2=70°, and θ2-2=4°, as shown in FIG. 28, the first anisotropic molecules in the first retardation layer 20 and the second anisotropic molecules in the second retardation layer 30 were in the respective hybrid alignments as in Comparative Example 2.

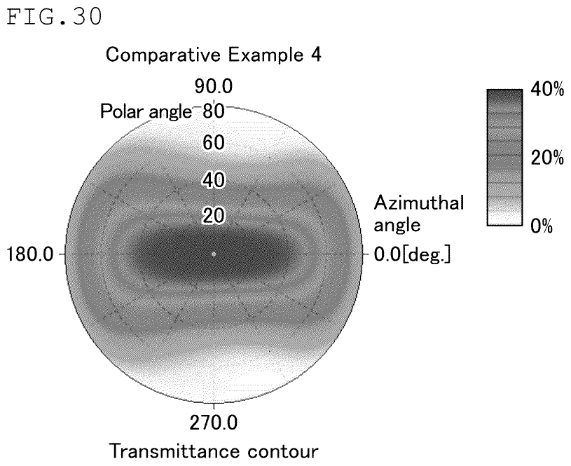

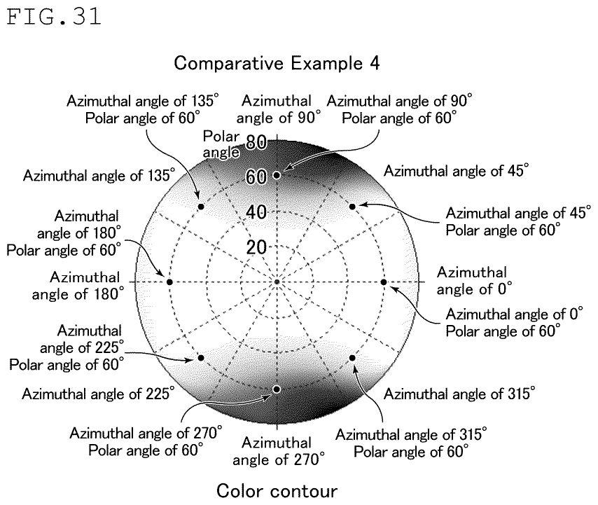

As in Example 1, the viewing angle in terms of transmittance and the coloring in the optical element of Comparative Example 4 were simulated. FIG. 30 shows simulation results of the viewing angle in terms of transmittance of the optical element of Comparative Example 4. FIG. 31 shows simulation results of the viewing angle in terms of color transmittance of the optical element of Comparative Example 4. The following Table 6 summarizes the x and y values in the xy chromaticity diagram of the optical element of Comparative Example 4 shown in FIG. 31 at a polar angle of 60° in the CIE 1931 color space. As shown in FIG. 30, the optical element of Comparative Example 4 successfully reduced oblique light at the azimuthal angle 90°-270°, but the light-blocking region was horizontally asymmetric about the azimuthal angle 90°-270° although being better than that in Comparative Example 1. As shown in FIG. 31 and Table 6, a bluish color and a yellowish color in mixture were observed at an oblique angle (polar angle of) 60°.

TABLE 6

| Azimuthal | | |
|---|---|---|
| angle [deg] | x | y |
| 0 | 0.33 | 0.36 |
| 45 | 0.34 | 0.32 |
| 90 | 0.43 | 0.26 |
| 135 | 0.38 | 0.38 |
| 180 | 0.33 | 0.36 |
| 225 | 0.38 | 0.38 |
| 270 | 0.43 | 0.26 |
| 315 | 0.34 | 0.32 |
| Average | 0.37 | 0.33 |
| chromaticity | | |
| value | | |

### Comparative Example 5

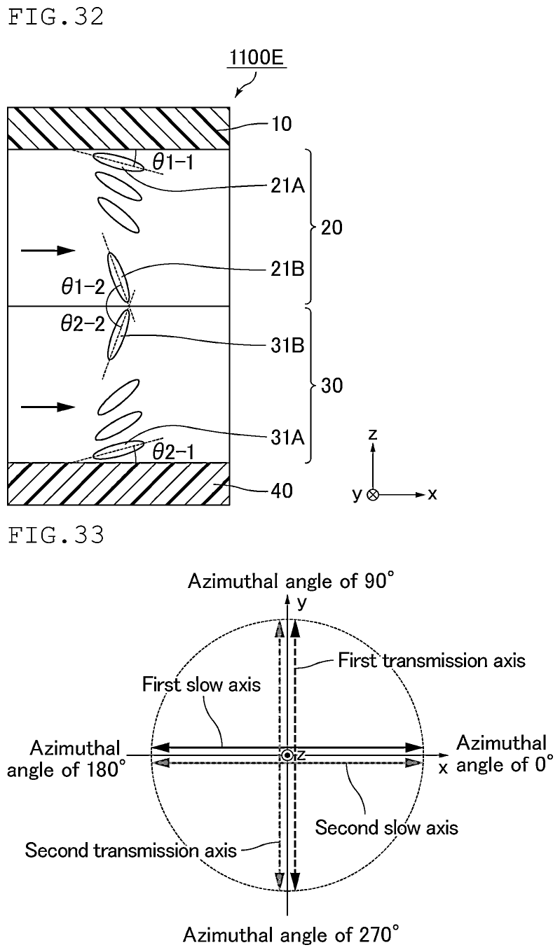

FIG. 32 is a schematic cross-sectional view of an optical element of Comparative Example 5. FIG. 33 shows axis azimuths of components of the optical element of Comparative Example 5. As shown in FIG. 33, the axis arrangement of the components was similar to that in Example 2. In an optical element 1100E of Comparative Example 5, θ1-1=4°, θ2-1=4°, θ1-2=70°, and θ2-2=70°. The in-plane retardations of the first retardation layer 20 and the second retardation layer 30 were each 213 nm.

As shown in FIG. 32, the first retardation layer 20 was in a hybrid alignment where the tilt angle of the first anisotropic molecules continuously decreases from the interface between the first retardation layer 20 and the second retardation layer 30 toward the first polarizer 10. The second retardation layer 30 was in a hybrid alignment where the tilt angle of the second anisotropic molecules continuously decreases from the interface toward the second polarizer 40. The changes in tilt angle of the first anisotropic molecules 21 and the second anisotropic molecules 31 were set symmetric about the interface between the first retardation layer 20 and the second retardation layer 30. Also, the direction of change in tilt angle of the first anisotropic molecules 21 was set the same as the direction of change in tilt angle of the second anisotropic molecules 31.

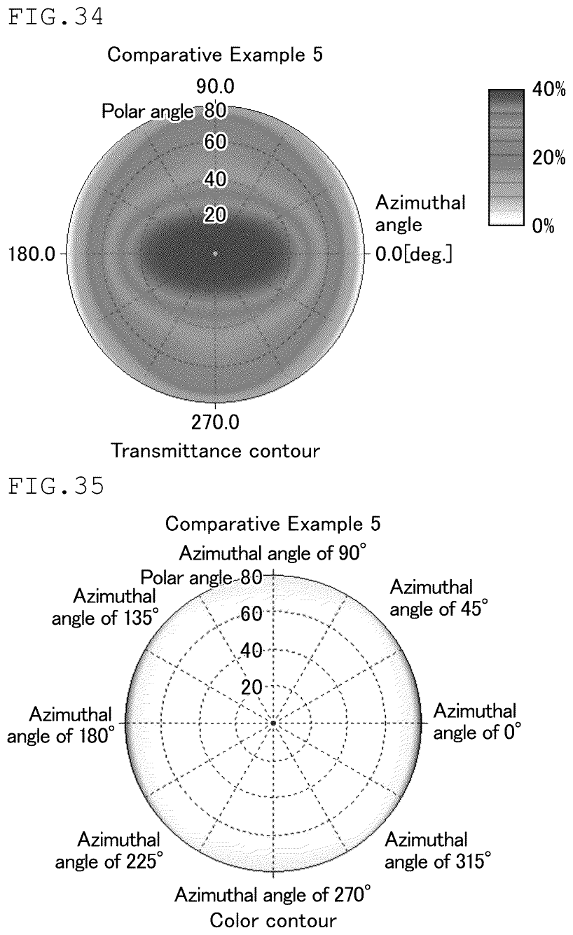

As in Example 1, the viewing angle in terms of transmittance in the optical element of Comparative Example 5 were simulated. FIG. 34 shows simulation results of the viewing angle in terms of transmittance of the optical element of Comparative Example 5. FIG. 35 shows simulation results of the viewing angle in terms of color transmittance of the optical element of Comparative Example 5. As shown in FIG. 34 and FIG. 35, the optical element of Comparative Example 5 successfully reduced oblique light at the azimuths in the left and right positions (azimuthal angle) 0°-180°, but failed to reduce oblique light at the azimuthal angle 90°-270°.

### Comparative Example 6

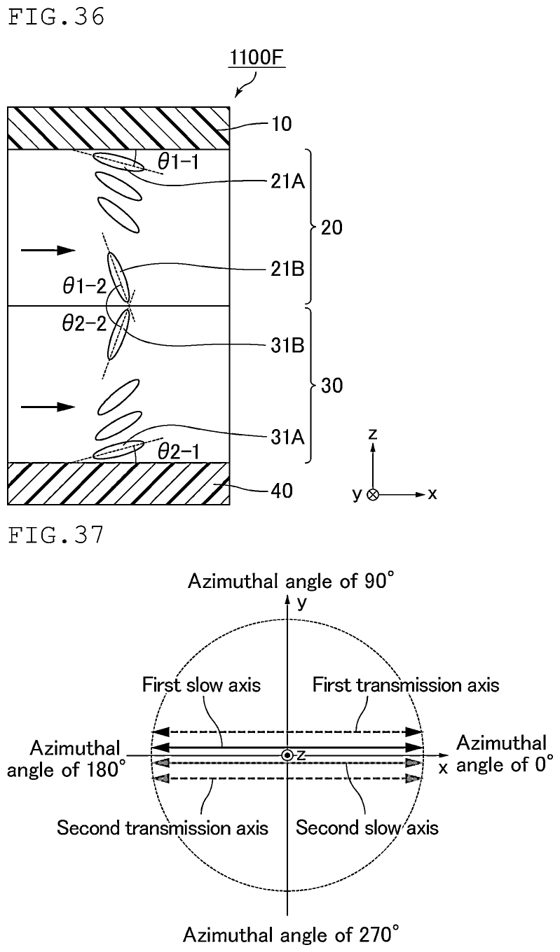

FIG. 36 is a schematic cross-sectional view of an optical element of Comparative Example 6. FIG. 37 shows axis azimuths of components of the optical element of Comparative Example 6. As shown in FIG. 37, the axis arrangement of the components was similar to that in Example 1. In an optical element 1100F of Comparative Example 6, with θ1-1=4°, θ2-1=4°, θ1-2=70°, and θ2-2=70°, as shown in FIG. 36, the first anisotropic molecules in the first retardation layer 20 and the second anisotropic molecules in the second retardation layer 30 were in the respective hybrid alignments as in Comparative Example 5.

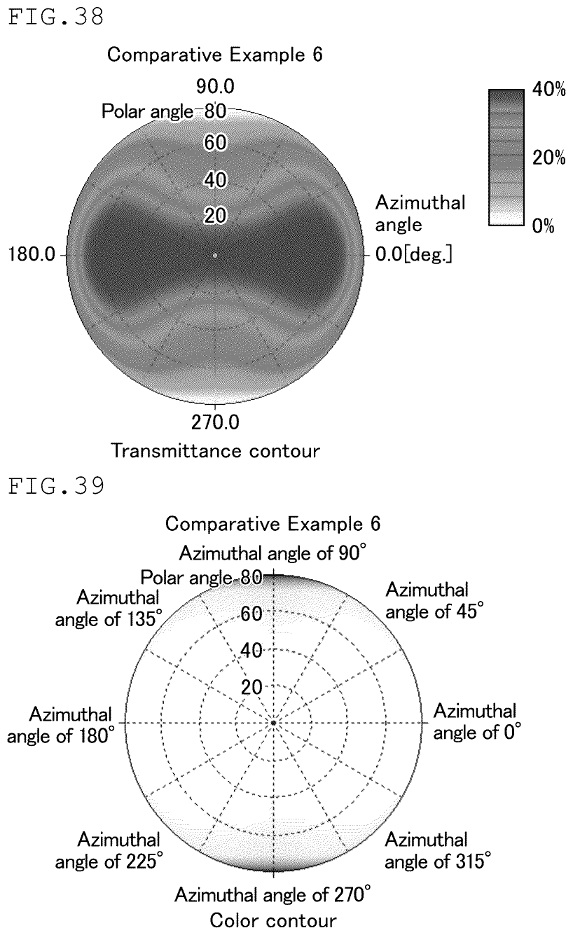

As in Example 1, the viewing angle in terms of transmittance in the optical element of Comparative Example 6 were simulated. FIG. 38 shows simulation results of the viewing angle in terms of transmittance of the optical element of Comparative Example 6. FIG. 39 shows simulation results of the viewing angle in terms of color transmittance of the optical element of Comparative Example 6. As shown in FIG. 38 and FIG. 39, the optical element of Comparative Example 6 had a narrower light-blocking range than in that of Example 1, and failed to sufficiently reduce light transmitted in an oblique direction (for example, polar angle of) 60° at the azimuths at the top and bottom positions (azimuthal angle) 90°-270°.

### REFERENCE SIGNS LIST

1: display device
10: first polarizer
20: first retardation layer
21: first anisotropic molecules
30: second retardation layer
31: second anisotropic molecule
40: second polarizer
100A, 100B, 1100A, 1100B, 1100C, 1100D, 1100E, 1100F: optical element
200: liquid crystal panel
300: backlight
301: prism sheet
301a: prism
301b: ridge line
400: observation surface side polarizer

What is claimed is:

1. An optical element comprising, in the following order from an observation surface side:
a first polarizer;
a first retardation layer containing first anisotropic molecules;
a second retardation layer containing second anisotropic molecules; and
a second polarizer,
wherein when a tilt angle of first anisotropic molecules of the first retardation layer located near the first polarizer is denoted by θ1-1, a tilt angle of first anisotropic molecules of the first retardation layer located near an interface with the second retardation layer is denoted by θ1-2, a tilt angle of second anisotropic molecules of the second retardation layer located near the second polarizer is denoted by θ2-1, and a tilt angle of second anisotropic molecules of the second retardation layer located near an interface with the first retardation layer is denoted by θ2-2,
the θ1-1 is greater than the θ1-2, with the tilt angles of the first anisotropic molecules continuously changing in a thickness direction of the first retardation layer,
the θ2-1 is greater than the θ2-2, with the tilt angles of the second anisotropic molecules continuously changing in a thickness direction of the second retardation layer,
a transmission axis of the first polarizer is parallel to a transmission axis of the second polarizer,
a slow axis of the first retardation layer is parallel to a slow axis of the second retardation layer, and
the transmission axis of the first polarizer is parallel to or orthogonal to the slow axis of the first retardation layer and the slow axis of the second retardation layer.

2. The optical element according to claim 1,
wherein the transmission axis of the first polarizer is parallel to the slow axis of the first retardation layer and the slow axis of the second retardation layer.

3. The optical element according to claim 1,
wherein the transmission axis of the first polarizer is orthogonal to the slow axis of the first retardation layer and the slow axis of the second retardation layer.

4. The optical element according to claim 2,
wherein the θ1-1 and the θ2-1 are each 65° or greater and 90° or smaller.

5. The optical element according to claim 3,
wherein the θ1-1 and the θ2-1 are each 70° or greater and 90° or smaller.

6. The optical element according to claim 1,
wherein the θ1-1 and the θ2-1 are each 70° or greater and 80° or smaller.

7. The optical element according to claim 1,
wherein a difference between the θ1-1 and the θ2-1 is 3° or less.

8. The optical element according to claim 1,
wherein the tilt angles of the first anisotropic molecules and the second anisotropic molecules change respectively in the thickness direction of the first retardation layer and in the thickness direction of the second retardation layer, with an interface between the first retardation layer and the second retardation layer as a plane of symmetry.

9. The optical element according to claim 1,
wherein the first polarizer is an absorptive polarizer or a laminate of an absorptive polarizer and a reflective polarizer, and
the second polarizer is a reflective polarizer or a laminate of an absorptive polarizer and a reflective polarizer.

10. A display device comprising, in the following order:
a liquid crystal panel;
the optical element according to claim 1; and
a backlight,
the optical element being disposed with the first polarizer being adjacent to the liquid crystal panel.

11. The display device according to claim 10,
wherein the backlight includes a prism sheet disposed in an optical element side of the backlight,
the prism sheet includes lines of linear bumps parallel to each other on an observation surface side surface thereof, and
a transmission axis of the first polarizer and a transmission axis of the second polarizer are parallel to or orthogonal to ridge lines of the linear bumps.
